(19) United States
(12) Patent Application Publication
(10) Pub. No.: US 2011/0225009 A1
(43) Pub. Date: Sep. 15, 2011

(54) SYSTEM AND METHOD FOR PROVIDING GEOGRAPHIC PRESCRIPTION DATA

(76) Inventors: Andrew E. KRESS, Gladwyne, PA (US); Jody Fisher, Yardley, PA (US); Steven Rosztoczy, Warrington, PA (US); James McKeown, Hartsvile, PA (US)

(21) Appl. No.: 12/723,117

(22) Filed: Mar. 12, 2010

(51) Int. Cl. G06Q 50/00; G06Q 10/00; G06Q 40/00; G06F 17/30

(52) U.S. Cl. 705/3; 707/802; 707/E17.044

(57) ABSTRACT

A system for providing geographic prescription data includes an input device, a presentation device, at least one database for storing electronic claims data and a computing platform in communication with the input device, the presentation device, and the at least one database. The input device receives user selections for at least one a portion of a region, a pharmaceutical, a category of pharmaceuticals, and a group of patients. The presentation device presents a report to the user comparing information about the selected portion of the region to another portion of the region. The computing platform receives a persons of interest list, correlates the stored electronic claims data with the persons of interest list such that all electronic claims data related to a person on the persons of interest list are correlated to the person, and provides the report for the selected portion of the region and the selected group of patients based on the correlation of the stored electronic claims data with the persons of interest list. The report includes prescriptions for the selected pharmaceutical, a comparison of the prescriptions for the selected pharmaceutical to the prescriptions for the same selected pharmaceutical for the other portion of the region, and a projected change in the prescriptions for the selected pharmaceutical based on at least one of a change in the patients prescribed the selected pharmaceutical and a change in the prescriptions per patients prescribed the selected pharmaceutical.

### FIELD OF THE INVENTION

The present invention relates to a system and a method for providing geographic prescription data. In particular, the present invention relates to a system and a method for providing geographic prescription data for a particular portion of a region and for a particular period of time.

### BACKGROUND OF THE INVENTION

Generally, pharmaceutical manufacturers provide data regarding sales of a particular drug annually, monthly, or some other period of time. The data is typically based on national sales data because the manufacturer is more concerned about total sales and production and not concerned about sales for a particular portion of the country. However, national sales data is not useful for some researchers and marketers because such data does not provide information about a particular region, city, or market. Instead, data about sales for a particular portion of a country or market would be much more useful to these researchers and marketers.

Researchers and marketers are presently limited to sales data which is typically provided annually and only covers the entire nation as a whole. Such data is too infrequent and cannot be easily broken down into sales for a particular part of the country. Consequently, that annual, national sales data cannot be easily and reliably converted into data for a specific time period or for a particular part of the country.

Thus, there is a need for a system and a method that provide geographic prescription data for a particular portion of a region and comparative data that compares the particular region and the whole region. The geographic prescription data should provide information for that portion of the region for a particular period of time, and thus the data should not be limited to national, yearly sales data alone. Also, the system and method should be able to provide other desired determinations based on the data. The system and method should be relatively faster and cost less than reviewing only annual, national sales data.

### SUMMARY OF THE INVENTION

Accordingly, an aspect of the invention is a system for providing geographic prescription data. The system includes an input device, a presentation device, at least one database for storing electronic claims data, and a computing platform in communication with the input device, the presentation device, and the at least one database. The input device receives user selections for at least one a portion of a region, a pharmaceutical, a category of pharmaceuticals, and a group of patients. The presentation device presents a report to the user comparing information about the selected portion of the region to another portion of the region. The computing platform receives a persons of interest list, correlates the stored electronic claims data with the persons of interest list such that all electronic claims data related to a person on the persons of interest list are correlated to the person, and provides the report for the selected portion of the region and the selected group of patients based on the correlation of the stored electronic claims data with the persons of interest list. The report includes prescriptions for the selected pharmaceutical, a comparison of the prescriptions for the selected pharmaceutical to the prescriptions for the same selected pharmaceutical for the other portion of the region, and a projected change in the prescriptions for the selected pharmaceutical based on at least one of a change in the patients prescribed the selected pharmaceutical and a change in the prescriptions per patients prescribed the selected pharmaceutical.

Another aspect of the invention is a system for providing geographic prescription data. The system includes an input device, a presentation device, at least one database for storing de-identified electronic claims data, and a computing platform in communication with the input device, the presentation device, and the at least one database. The input device receives user selections for at least one a portion of a region, a pharmaceutical, a category of pharmaceuticals, and a group of patients. The presentation device presents a report to the user comparing information about the selected portion of the region to another portion of the region. The computing platform receives a persons of interest list, de-identifies the persons of interest list in the same manner as the stored de-identified electronic claims data, correlates the de-identified stored electronic claims data with the de-identified persons of interest list such that all electronic claims data related to a person on the de-identified persons of interest list are correlated to the person, and provides the report for the selected portion of the region and the selected group of patients based on the correlation of the stored de-identified electronic claims data with the de-identified persons of interest list. The report includes prescriptions for the selected pharmaceutical, a comparison of the prescriptions for the selected pharmaceutical to the prescriptions for the same selected pharmaceutical for the other portion of the region, and a projected change in the prescriptions for the selected pharmaceutical based on at least one of a change in the patients prescribed the selected pharmaceutical and a change in the prescriptions per patients prescribed the selected pharmaceutical.

Yet another aspect of the invention is a system for providing geographic prescription data. The system includes an input device, a presentation device, at least one database for storing de-identified electronic claims data, and a computing platform in communication with the input device, the presentation device, and the at least one database. The input device receives user selections for at least one a portion of a region, a pharmaceutical, a category of pharmaceuticals, and a group of patients. The presentation device presents a report to the user comparing information about the selected portion of the region to another portion of the region. The computing platform receives a persons of interest list, de-identifies the persons of interest list in the same manner as the stored de-identified electronic claims data, correlates the de-identified stored electronic claims data with the de-identified persons of interest list such that all electronic claims data related to a person on the de-identified persons of interest list are correlated to the person, determines metrics based on geography and the correlation of the stored de-identified electronic claims data with the de-identified persons of interest list, and provides the report for the selected portion of the region and the selected group of patients based on the correlation of the stored de-identified electronic claims data with the de-identified persons of interest list. The report includes prescriptions for the selected pharmaceutical, a comparison of the prescriptions for the selected pharmaceutical to the prescriptions for the same selected pharmaceutical for the other portion of the region, and a projected change in the prescriptions for the selected pharmaceutical based on at least one of a change in the patients prescribed the selected pharmaceutical and a change in the prescriptions per patients prescribed the selected pharmaceutical.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram of a system for providing geographic prescription data in accordance with an exemplary embodiment of the invention;

FIG. 2 is a flow diagram for a method for providing geographic prescription data in accordance with another exemplary embodiment of the invention;

FIG. 3 is an example report outputted by the system illustrated in FIG. 1 or the method illustrated in FIG. 2;

FIG. 4 is another example report outputted by the system illustrated in FIG. 1 or the method illustrated in FIG. 2;

FIG. 5 is a portion of an example report outputted by the system illustrated in FIG. 1 or the method illustrated in FIG. 2;

FIG. 6 is a portion of an example report outputted by the system illustrated in FIG. 1 or the method illustrated in FIG. 2;

FIG. 7 is a portion of an example report outputted by the system illustrated in FIG. 1 or the method illustrated in FIG. 2;

FIG. 8 is a portion of an example report outputted by the system illustrated in FIG. 1 or the method illustrated in FIG. 2;

FIG. 9 is a portion of an example report outputted by the system illustrated in FIG. 1 or the method illustrated in FIG. 2;

FIG. 10 is a portion of an example report outputted by the system illustrated in FIG. 1 or the method illustrated in FIG. 2;

FIG. 11 is a portion of an example report outputted by the system illustrated in FIG. 1 or the method illustrated in FIG. 2;

FIG. 12 is a portion of an example report outputted by the system illustrated in FIG. 1 or the method illustrated in FIG. 2; and

FIG. 13 is an example report outputted by the system illustrated in FIG. 1 or the method illustrated in FIG. 2.

### DETAILED DESCRIPTION OF THE INVENTION

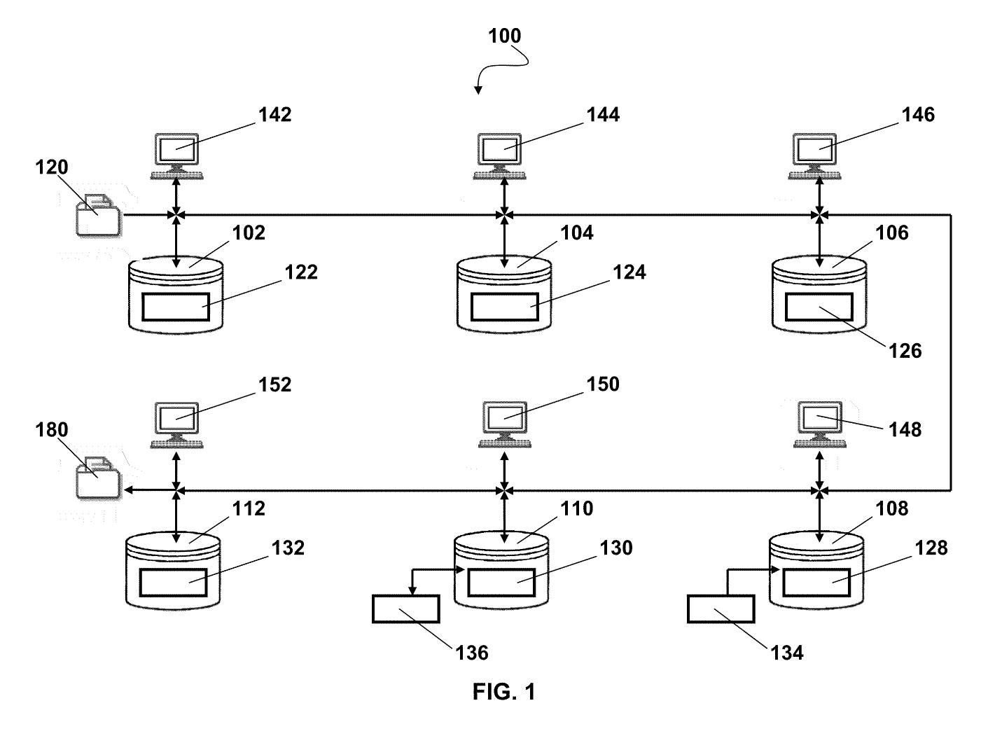

Referring to FIGS. 1-12, the present invention provides a system 100 and a method 200 for providing geographic prescription data. The system 100 and method 200 can provide geographic prescription data for a particular portion of a region and comparative data that compares the particular region and the whole region. The geographic prescription data uses non-electronic data 120 from claim forms to provide information for a region, and thus the data is not limited to national, yearly sales data alone. The system 100 and method 200 can also provide other desired determinations based on the data 120. In an exemplary embodiment, the system 100 and the method 200 can provide data that is based on patients and that is particularly suited for marketers. In such an embodiment, the system 100 and the method 200 can provide determinations based on tracking the use of a particular pharmaceutical by one particular patient at different points in time. For example, the system 100 and method 200 can provide the total number of patients and not merely the total number of prescriptions, the total prescriptions per patient, number of new to brand prescriptions, persistence which provides the number of patients remaining on a particular therapy after a predetermined period of time, or compliance which provides the number of patients that had a supply of a particular pharmaceutical during their treatment regimen.

For the sake of clarity and simplifying the description of the invention, the system 100 and the method 200 are described for an embodiment that receives non-electronic data 120 in the form of claims for prescriptions. However, the invention is not limited to only such an embodiment. In other embodiments, the invention can use non-electronic data 120 from medical claims, dental claims, some combination of the aforementioned, or some other form of non-electronic data 120 that involves removal of personally identifiable information and correlating that the resulting de-identified information with other information.

Referring to FIG. 1, the system 100 includes at least one database 102, 104, 106, 108, 110, or 112. One or more of the databases 102, 104, 106, 108, 110, and 112 can be combined with each other. Each of the databases 102, 104, 106, 108, 110, and 112 can receive, store, and transmit data 122, 124, 126, 128, 130, and 132, respectively. In other embodiments, one or more of the data 122, 124, 126, 128, 130, and 132 can be combined into one and stored on one or more of the databases 102, 104, 106, 108, 110, and 112. Also, each of the databases 102, 104, 106, 108, 110, and 112 can be a part of, electronically coupled to, or in communication with a computing platform 142, 144, 146, 148, 150, and 152, respectively. In other embodiments, one or more of the computing platforms 142, 144, 146, 148, 150, and 152 can be combined into one, or one computing platform may be communicating with all the databases 102, 104, 106, 108, 110, and 112. Alternatively, more than one computing platform 142, 144, 146, 148, 150, or 152 may be in communication with one of the databases 102, 104, 106, 108, 110, 112. One user may operate or control all the computing platforms 142, 144, 146, 148, 150, or 152. Or, in another embodiment, one or more users can operate or control one or more of the computing platforms 142, 144, 146, 148, 150, and 152.

The first database 102 receives non-electronic data 120 that can be stored electronically as raw data 122. The non-electronic data 120 can be converted into electronic raw data 122 by scanning, character recognition, combinations of the aforementioned, or some other system or method for converting non-electronic data into electronic data. The first database 102 can be located at a pharmacy, a physician's office, a hospital, a laboratory, a health insurer, a consultancy, a software vendor, a claims clearinghouse, or any other similar facility where non-electronic data 120 is produced, collected, received, provided, or otherwise handled. The non-electronic data 120 can be received from several different geographic locations, such as from one or more geographically disparate pharmacies, physician's offices, hospitals, laboratories, health insurers, consultancies, software vendors, clearinghouses, and the like. The non-electronic data 120 can be formatted such that requested information is received in a particular order, in a particular area of a form, or in some other organized manner. The non-electronic data 120 can be converted into electronic raw data 122 after a form has been filled out or as information is provided verbally, by typing, or by writing. The raw data 122 can be stored in accordance with a particular format that is widely used, created specifically for the system 100, or some other acceptable format. Widely used formats include NCPDP 5.1, CMS-1500/837p, CMS-1450/UB-92/UB-40/837i, and other similar formats. In other embodiments, the system 100 may use more than one format, and the user can instruct the system 100 to receive data for a selected format.

The first computing platform 142 is in communication with the first database 102. The first computing platform 142 can be located at a pharmacy, a physician's office, a hospital, a laboratory, a health insurer, a consultancy, a software vendor, a claims clearinghouse, or any other similar facility where non-electronic data 120 is produced, collected, received, provided, or otherwise handled. The first computing platform 142 can ask for or receive from a user, non-electronic data 120, an electronic form, or the like each required field of non-electronic data 120 in a particular format and then store each required field in a file in the first database 102 prearranged to receive each required field of the particular format used by the system 100. The first computing platform 142 can also de-identify the raw data 122, for example with the system and method described in U.S. Patent Appl. Pub. No. 2008/0147554, entitled “System and Method for the De-Identification of Health Care Data,” by Stevens et al. filed on Nov. 27, 2007, which is incorporated herein in its entirety by reference. Because personally identifying information is largely removed from the raw data 122, the first computing platform 142 can append a substitute means of identifying one particular set of data from one particular claim form, such as a random or unique identifier or anonymous linking code. Or, the first computing platform 142 can append some other marker or flag signifying or describing a particular predetermined attribute found within the data. Thereafter, the first computing platform 142 can correlate raw data 122 that are from or regarding the same patient or claimant. The first computing platform 142 can also validate that the raw data 122 is correctly formatted or that it is not electronically corrupted.

In the embodiment depicted in FIG. 1, the first database 102 extracts or receives non-electronic data 120 from, for example, a prescription claim form submitted by a pharmacy in NCPDP 5.1 format which has certain predetermined fields for prescription claims. The first database 102 can also receive non-electronic data 120 from other types of claim forms, such as emergency care claim forms, outpatient care claim forms, and other similar claim forms. The non-electronic data 120 from the claim forms is converted manually or automatically (such as by scanning and text recognition) into electronic claims data that is stored as the raw data 122. The electronic claims data can be stored locally where the claim form was generated or transmitted and stored in a database (not shown) at a claims clearinghouse, where electronic claim forms are received and processed for payment by a payor, such as a health insurer. A healthcare provider electronically submits healthcare data to receive payment for services rendered. The data flows from the healthcare provider to a clearinghouse or a provider of electronic data interchange and related services. Healthcare data submitted can include the patient's name, standardized codes to describe the diagnosis made, services performed, and products used. Thus, although shown as a single database 102, the first database 102 can be the database where the claims data is first entered, a database at a clearinghouse, or both. The system 100 can be adapted to communicate with either database to receive or extract electronic claims data stored as raw data 122. The data received or extracted can include, for example, the name of a pharmaceutical prescribed, the location of a pharmacy, and the date and time listed on a prescription claim form. The first computing platform 142 can remove any personally identifiable information that can be used to positively identify a person and replace personally identifiable information with a unique identifier.

The second database 104 is in communication with the first database 102. The second database 104 stores partial raw data 124, which is a condensed, more relevant portion of the raw data 122 stored in the first database 102. The partial raw data 124 may include only raw data 122 from a particular type of non-electronic data 120, such as non-electronic data 120 from prescription claims; non-electronic data 120 with a particular entry in a data field, such as a particular location; non-electronic data 120 from a particular time period, such as within the last month; or some other criteria that segregates more relevant raw data 122 from other raw data 122. The first computing platform 142 and/or the second computing platform 144 can filter, sort, or search the raw data 122 and save partial raw data 124 in the second database 104. In other embodiments, substantially all of the raw data 122 stored in the first database 102 can be stored in the second database 104. The second database 104 can also be located remote from the first database 102 such that the second database 104 is more conveniently located.

The second computing platform 144 is in communication with the second database 104. The second computing platform 144 can analyze the partial raw data 124 to determine statistically absent relevant raw data or erroneous raw data. Due to errors in collecting, storing, or otherwise handling non-electronic data 120, there may be some non-electronic data 120 that was not entered into the system 100 or erroneously entered into the system 100. Thus, the second computing platform 144 can verify data integrity or provide data validation. For example, there may be an omitted value in the non-electronic data 120. In some embodiments, the second computing platform 144 can provide a reasonable value for the omitted value based on reference data, interpolation based on other historic data, or some other source of reasonable data. For instance, if the quantity for a particular pharmaceutical was omitted, the second computing platform 144 can search for the NCD11, an industry standard product identification number, associated with the pharmaceutical and find that the pharmaceutical is available only in a certain unit size that cannot be subdivided into smaller units. Thereafter, the second computing platform 144 can insert that certain unit size for the omitted quantity value. In another example, one particular value in the non-electronic data 120 may be outside a reasonable range, such as the value for “days of supply.” The non-electronic data 120 may indicate 5,000 days of supply, but the expected value has to be between 1 and 365 for a year-long period of time. Thus, the second computing platform 144 determines by appropriate statistical measures whether the partial raw data 124 contains all relevant data.

In the embodiment shown in FIG. 1, the second database 104 is in communication with a first database 102. Although the second database 104 is shown communicating with a single first database 102, the second database 104 can be in communication with more than one first database 102. For example, in another embodiment of system 100, the second database 104 can be communicating with first databases 102 that are located at several pharmacies and another first database 102 that is located at a clearinghouse. The second database 104 extracts or receives raw data 122 from the first database 102 related to, for example pharmacies and prescriptions for the last month. The second computing platform 144 then analyzes the partial raw data 124 stored in the second database 104 to statistically determine whether claims data is omitted, erroneous, or otherwise invalid. For example, not all of the non-electronic data 120 may be entered into the system 100, because not every prescription from every pharmacy can be entered, or the system 100 cannot access non-electronic data 120 provided by certain pharmacy chains or claims processors. When the system 100 cannot access non-electronic data 120 provided by certain pharmacy chains or claims processors, the second computing platform 144 can determine the missing relevant data by accessing non-electronic data 120 of the claims processor for a certain pharmacy or chain of pharmacies. Thus, the second computing platform 144 can determine the probable totality of claims related to pharmaceuticals to minimize errors due to collecting or handling claims data. The second computing platform 144 can then store as the partial raw data 124 a portion of the raw data 122 that has been analyzed for omitted, erroneous, or otherwise invalid values in the second database 104.

The third database 106 is in communication with the second database 104. The third database 106 stores a dataset 126 derived from the partial raw data 124. The third computing platform 146 is in communication with the third database 106. There may be more than one second database 104, and thus the third computing platform 146 would be in communication with all second databases 104. The third computing platform 146 organizes the partial raw data 124 from one or more second databases 104 into the dataset 126. A single dataset 126 is preferred so that only a single database or set of data has to be accessed for making determinations about the dataset 126. The third database 106 and third computing platform 146 can be located remote from the other databases 102, 104, 108, 110, and 112 and the other computing platforms 142, 144, 148, 150, and 152 such that the third database 106 and the third computing platform 146 are more conveniently located.

The fourth database 108 is in communication with the third database 106. The fourth database 108 stores a patient level dataset 128. The fourth database 108 can also receive and store a persons of interest list 134. The persons of interest list 134 can be a list of clients, customers, consumers, subscribers, or some other predetermined group of persons. The persons of interest list 134 can be provided by a user, such as a researcher, a marketer, a subscription service provider, or some other entity that is interested in examining a certain group of persons or examining persons in a particular portion of a region. The persons of interest list 134 can be provided electronically or manually inputted into the system 100. The persons of interest list 134 can be used to obtain information from the dataset 126 related to any individual listed in the persons of interest list 134.

The fourth computing platform 148 is in communication with the fourth database 108. The fourth computing platform 148 analyzes the dataset 126 stored in the third database 106 to acquire the occurrences of certain characteristics in the dataset 126. The fourth computing platform 148 can filter the dataset 126 with the persons of interest list 134 to identify data related to a particular person on the persons of interest list 134. Preferably, the fourth computing platform 148 analyzes a single dataset 126 stored at a single database 106.

In the embodiment shown, the fourth computing platform 148 analyzes the dataset 126 comprised of claims data related to pharmaceuticals prescribed in a particular period of time (such as within a day, several days, a week, several weeks, a month, several months, or some other period of time) for any information related to any individual listed on the persons of interest list 134. For instance, the fourth computing platform 148 can analyze the dataset 126 for a particular month to find if any individual listed on the persons of interest list 134 is connected with a particular brand of pharmaceuticals, whether the particular brand is branded or generic, the category within which the particular brand belongs, the age of the person prescribed the pharmaceutical, the gender of the person prescribed the pharmaceutical, and other similar information. Thus, the fourth computing platform 148 can correlate a particular person on the persons of interest list 134 to pharmaceutical claims data in the dataset 126.

Also, in the depicted embodiment, the fourth computing platform 148 can determine that a particular prescription is a new prescription (NRx) if the non-electronic data 120 or dataset 126 indicates that a particular prescription is not a refill. The fourth computing platform 148 can determine total prescriptions (TRx), in the dataset 126. Total prescriptions includes new prescriptions and refill prescriptions. The fourth computing platform 148 can determine total prescriptions for a particular pharmaceutical or a particular category of pharmaceuticals. The fourth computing platform 148 can determine the number of unique patients in the dataset 126, determine the number of patients filling a prescription for a particular brand, determine the number of patients within a particular category of pharmaceuticals, and other similar determinations and divisions of patients. The fourth computing platform 148 can determine the total prescriptions per patient (TRx/patient). The fourth computing platform 148 can determine new to brand prescriptions as a fraction or percentage of the total prescriptions (NTB Rx %). A new to brand prescription includes those prescriptions filled by patients who are new to a particular pharmaceutical or who have switched from another pharmaceutical within the same category of pharmaceuticals. The NRx, TRx, TRx/patient, and NTB Rx % can be stored in the fourth database 108 with the dataset 128.

The depicted fourth database 108 can receive and store population data for a particular region or a portion of a region. In the embodiment shown, the fourth database 108 stores the latest census data for the United States. The census data can be segmented by age, gender, and geography. As an example, the fourth database 108 receives and stores a persons of interest list 134 that includes subscribers of a cable company or a satellite television provider. The fourth computing platform 148 can filter the dataset 126 to find claims related to persons listed on the persons of interest list 134. Because the dataset 126 includes de-identified claims data, the fourth computing platform 148 can de-identify the persons of interest list 134 by using the same methodology as the one used for de-identifying the non-electronic data 120 so that one particular de-identified entry on the persons of interest list 134 can be matched to corresponding de-identified entry in the dataset 126. By matching persons in the dataset 126 to corresponding persons on the persons of interest list 134 by this method, the system 100 can handle data that contains no personally identifiable information so that the system 100 ensures no personally identifiable information is released when the fourth computing platform 148 transmits the results of matching the dataset 126 with the persons of interest list 134. The fourth computing platform 148 can then determine brands, categories of pharmaceuticals, ages, and other similar information for each person listed on the persons of interest list 134. In other embodiments, the persons of interest list 134 can be received with the raw data 122, and the raw data 122 can be matched against the persons of interest list 134 at the first database 102 before the raw data 122 is de-identified.

The fifth database 110 is in communication with the fourth database 108. The fifth database 110 stores predetermined metrics 136. The metrics 136 may be based on geography, time, a particular brand, a particular vendor, combinations of the aforementioned, or some other predetermined parameter. The fifth computing platform 150 is in communication with the fifth database 110. The fifth computing platform 150 determines, at least, parameters that are geography specific, time specific, brand specific, or vendor specific using the metrics 136 stored in fifth database 110 for the patient level dataset 128 stored in the fourth database 108. The results of these determinations are stored as the analyzed dataset 130.

In an illustrative example, the fifth database 110 stores an analyzed dataset 130 formed from metrics 136 based on geography being applied to the patient level dataset 128. The fifth computing platform 150 applies the metrics 136 to analyze the patient level dataset 128 for a particular division of a region, such as those based on a particular local media buying region or metropolitan. In one embodiment, the fifth computing platform 150 can use the metric 136 to divide households located in the United States into markets or geographic areas, generally located around the largest cities and towns, similar to the geographic partitions already used by marketing entities to determine where to market certain products through commercials, such as those on television, on radio, or in newspapers and magazines.

The depicted fifth computing platform 150 can determine a brand development index (BDI) which provides a measurement of the popularity of a particular pharmaceutical in a particular portion of a region compared to the popularity of that same particular pharmaceutical in the region as a whole. To provide the BDI, the fifth computing platform 150 determines the occurrence of a particular brand of pharmaceuticals within its category in a particular portion of a region, determines the occurrence of the same brand of pharmaceuticals for the whole region, and develops a fraction or a percentage. For example, the fifth computing platform 150 may determine that Drug A in the category of drugs for treating Multiple Sclerosis was prescribed in 17% of the prescriptions for drugs in that category for the Boston area. Within the same time period, Drug A was prescribed in 22% of all prescriptions including a drug for treating Multiple Sclerosis in the United States. Thus, the BDI would be proportional to 17%/22% or 0.80. A BDI over 1.0 indicates that a drug is more popular in that portion of the region than the region as a whole, while a BDI under 1.0 indicates the drug is not as popular in that portion of region as for the whole region. Thus, for Drug A, it is not as popular for Multiple Sclerosis prescriptions in the Boston area as it is for the United States as a whole. Accordingly, marketers may be interested in directing marketing resources and efforts in Boston to raise the occurrence of Drug A being prescribed for Multiple Sclerosis.

The fifth computing platform 150 can also determine a group specific BDI in accordance with the persons of interest list 134 stored in the fourth database 108. The fifth computing platform 150 determines the occurrence of a particular brand of pharmaceuticals within its category in a particular portion of a region, determines the occurrence of the same brand of pharmaceuticals in the same portion of the region for the persons listed on the persons of interest list 134, and develops a fraction or a percentage. For example, the persons of interest list 134 may be comprised of subscribers of a particular cable television provider in the Boston area, and the fifth computing platform 150 may determine that Drug A in the category of drugs for treating Multiple Sclerosis was prescribed in 17% of the prescriptions for drugs in that category for the Boston area. Within the same time period, Drug A was prescribed in 19% of the prescriptions for the persons on the persons of interest list 134 or in 19% of the prescriptions for the subscribers of the cable television provider in the same Boston area. Thus, the group specific BDI would be proportional to 19%/17% or 1.12. A group specific BDI over 1.0 indicates that a drug is more popular in that particular group compared to all patients in a particular portion of the region, while a group specific BDI under 1.0 indicates the drug is not as popular in that particular group when compared to all patients in that particular portion of the region. Thus, for Drug A, it is more popular for Multiple Sclerosis prescriptions in the group comprised of persons on the persons of interest list 134 for the Boston area when compared to all patients filling a prescription for Multiple Sclerosis in the Boston area. Accordingly, marketers may be less interested in directing marketing resources towards subscribers of that particular cable television service in Boston because that group of subscribers is prescribed Drug A more often than similar patients in the Boston area. Alternatively, marketers may be more interested in directing marketing resources towards those subscribers if they desire to increase the prescription of Drug A in that group of subscribers or if they want to retain those already being prescribed Drug A.

Because the system 100 can group pharmaceuticals into categories (such as Multiple Sclerosis, cholesterol, high blood pressure, and the like), a determination similar to BDI can be made for categories of pharmaceuticals. The fifth computing platform 150 can compare the population in a portion of a region being treated by pharmaceuticals in a particular category to the whole population of the whole region being treated by pharmaceuticals in the same category to arrive at a category development index (CDI). For example, the fifth computing platform 150 can compare the population in the Boston area being treated for Multiple Sclerosis to the population in the United States being treated for Multiple Sclerosis. For instance, the Boston area may have 2,777 patients prescribed a pharmaceutical in the Multiple Sclerosis category out of a population of 6.3 million people, and in the United States, 98,276 patients are prescribed a pharmaceutical in the Multiple Sclerosis category out of a population of 304 million. Thus, the CDI would be proportional to (2,777/6,342,246)/(98,276/304,009,593) or 1.35. A CDI greater than 1.0 indicates that a greater portion of the population within a particular portion of a region is being treated with pharmaceuticals in the same category than a similarly treated portion of the population within the whole region. Thus, a CDI of 1.35 for the Boston area indicates a greater portion of the Boston area population is being treated with a pharmaceutical in the Multiple Sclerosis category when compared to the portion of the U.S. population being treated with a pharmaceutical in the same category.

The fifth computing platform 150 can also determine a group specific CDI in accordance with the persons of interest list 134 stored in the fourth database 108. The fifth computing platform 150 determines the occurrence of pharmaceuticals within a particular category in a particular portion of a region, determines the occurrence of pharmaceuticals in the same category for the same portion of the region for the patients listed on the persons of interest list 134, and develops a fraction or a percentage. For example, the fifth computing platform 150 may determine that the Boston area has 2,777 patients prescribed a pharmaceutical in the Multiple Sclerosis category out of a population of 6.3 million people, while only 21 out of 30,000 persons on the persons of interest list 134 in the Boston area is prescribed a pharmaceutical in the Multiple Sclerosis category. Thus, the group specific CDI would be (21/30,000)/(2,777/6,342,246) or 1.60. A group specific CDI over 1.0 indicates that pharmaceuticals in a particular category are more popular in that particular group when compared to all similarly prescribed patients in a particular portion of the region, while a group specific CDI under 1.0 indicates the pharmaceuticals in a particular category are not as popular in that particular group when compared to all similarly prescribed patients in that particular portion of the region. Thus, for pharmaceuticals in the Multiple Sclerosis category, they are more often prescribed for persons listed on the persons of interest list 134 in the Boston area than for the general population of the Boston area. Accordingly, marketers of Multiple Sclerosis drugs may be more interested in directing marketing resources towards subscribers of a particular cable television service in the Boston area because that group of subscribers is prescribed drugs in the Multiple Sclerosis category more often than similar patients in the Boston area.

As described above, the fourth computing platform 148 can determine a total prescriptions per patient (TRx/patient). In the embodiment shown, the fourth computing platform 148 determines the total number of prescriptions for a particular pharmaceutical and determines the total number of persons receiving a prescription for a region or a portion of that region from the dataset 126. The TRx/patient can be stored with the patient level dataset 128 in the fourth database 108. For example, the fourth computing platform 148 may determine that, in the dataset 126, there are 63,475 prescriptions for Drug A and 13,603 unique patients in the United States. Thus, the TRx/patient would be 63,475/13,603 or 4.67 Drug A prescriptions per patient in the United States.

The fifth computing platform 150 can determine a treatment index (TI) that compares the TRx/patient for a particular portion of a region and the TRx/patient for the whole region for a particular pharmaceutical or a category of pharmaceuticals from the patient level dataset 128 stored in the fourth database 108. For example, in the Multiple Sclerosis category, the fifth computing platform 150 can determine that the Boston area has 4.03 prescriptions per patient, while for the same category, the fifth computing platform 150 determines that the TRx/patient for the United States is 4.13. Thus, the TI would be (4.03)/(4.13) or 0.98. A TI above 1.0 indicates that a greater portion of the population within a particular portion of a region has a prescription when compared to the portion of the population with a prescription in the same category for the whole region. Likewise a TI below 1.0 indicates that a smaller portion of the population within a particular portion of a region has a prescription when compared to the portion of the population with a prescription in the same category for the whole region. Thus, a TI of 0.98 for the Boston area indicates a smaller portion of the Boston area population has a prescription in the Multiple Sclerosis category when compared to the portion of the U.S. population with a prescription in the same category.

The fifth computing platform 150 can determine a group specific TI based on the persons of interest list 134 stored in the fourth database 108. The fifth computing platform 150 determines the total prescriptions per patient for persons listed in the persons of interest list 134 for a particular portion of a region and develops a fraction or a percentage based on the TRx/patient for that same portion of the region. For example, the fifth computing platform 150 may determine that the Boston area has 4.03 prescriptions per patient in the Multiple Sclerosis category, while there are only 3.87 prescriptions per patient for persons on the persons of interest list 134. Thus, the group specific TI would be (3.87)/(4.03) or 0.96. A group specific TI over 1.0 indicates that there are more prescriptions per person in a particular group when compared to the prescriptions per person for a particular region or a portion of that region. A group specific TI under 1.0 indicates fewer prescriptions per person in a particular group when compared to the prescriptions per person for a particular region or a portion of that region. Thus, for pharmaceuticals in the Multiple Sclerosis category, there are less prescriptions per person in the Boston area than for the general population of the Boston area. Accordingly, marketers of Multiple Sclerosis drugs may be less interested in directing marketing resources towards subscribers of a particular cable television service in the Boston area because that group of subscribers has fewer prescriptions in the Multiple Sclerosis category when compared to the Boston area as a whole.

As described above, the fourth computing platform 148 can determine a NTB Rx %. The fifth computing platform 150 can retrieve the NTB Rx % stored in the fourth database 108 and determine a new to brand index (NTBI). The NTBI compares the NTB Rx % for a particular region and the NTB Rx % for a particular portion of that region. For example, the fourth computing platform 148 may determine that for the Multiple Sclerosis category, 6.5% of the prescriptions in the U.S. are new to brand because the prescriptions were filled by patients who are new to a pharmaceutical in the category or who have switched from another pharmaceutical in the same category. The fifth computing platform 150 may determine that, in the Boston area, 3.3% of the prescriptions are new to brand. Thus, the NTBI for the Boston area is (3.3%)/(3.4%) or 0.99. An NTBI less than 1.0 indicates that there are fewer new to brand prescriptions in a particular portion of a region when compared to prescriptions in the whole region. Likewise, an NTBI greater than 1.0 indicate that there are more new to brand prescriptions in a particular portion of a region when compared to prescriptions in the whole region. Thus, for the Boston area, there are fewer new to brand prescriptions when compared to the U.S. as a whole. Marketers may then surmise that people with prescriptions in the Boston area are less likely to switch pharmaceuticals when compared to the general U.S. population.

The fifth computing platform 150 can determine a group specific NTBI based on the persons of interest list 134 stored in the fourth database 108. The fifth computing platform 150 determines the new to brand prescriptions for persons listed in the persons of interest list 134 for a particular portion of a region and develops a fraction or a percentage based on the NTB Rx % for that same portion of the region. For example, the fifth computing platform 150 may determine that, in the Boston area, 3.3% of all prescriptions are new to brand for Drug A, while only 3.1% of prescriptions for persons on the persons of interest list 134 are new to brand for Drug A. Thus, the group specific NTBI would be (3.1)/(3.3) or 0.94. A group specific NTBI over 1.0 indicates that there are more new to brand prescriptions for persons in a particular group when compared to prescriptions for a particular region or a portion of that region. A group specific NTBI under 1.0 indicates fewer new to brand prescriptions for persons in a particular group when compared to prescriptions for a particular region or a portion of that region. Thus, for Drug A, there are less new to brand prescriptions in the Boston area than in the U.S. Accordingly, marketers of Drug A may be less interested in directing marketing resources towards subscribers of a particular cable television service in the Boston area because that group of subscribers has fewer new to brand prescriptions in the Multiple Sclerosis category when compared to the Boston area as a whole.

The fifth computing platform 150 can determine compliance or a measure of how much supply of a particular pharmaceutical a patient had in comparison to the length of time the patient was on a particular therapy. For example, the fifth computing platform 150 can determine the total days of supply that a patient had for a particular pharmaceutical compared to the total days the patient was in a particular therapy. Compliance may be calculated for all patients with two or more prescriptions. For example, a particular patient may have had a 90 day supply of Drug A during 103 days that the patient was in therapy. Thus, for this particular patient, compliance is proportional to 90/103 or 86.5%. A compliance rate less than 100% indicates some delays in filling prescriptions or some gaps in therapy. Values for each individual patient can be aggregated to find compliance for a particular brand, a particular category, or a particular region or portion of the region.

The fifth computing element 150 can determine persistence or a measure of how many patients remain on a particular therapy after a certain period of time. Patients are considered persistent if they continue to have supplies of a certain pharmaceutical through the period of time of interest. Persistence can be determined for all patients. For example, the fifth computing platform 150 can determine that one patient had a supply of Drug A on hand for six consecutive months, another patient had a supply of Drug A on hand for twelve consecutive months, and yet another patient had a supply of Drug A on hand for one month. Thus, for Drug A, persistency in a twelve month period of time is proportional to one patient out of three patients or 33%, or 33% of patients remained persistent after twelve months.

The fifth computing platform 150 can determine a compliance index (CI) that compares the compliance rate for a portion of a region to the compliance rate of the region as a whole. The CI can be determined for each category and for each pharmaceutical. For example, the fifth computing platform 150 may determine that, for the Boston area, 88.3% of persons with a prescription for Drug A are compliant, and that, for the U.S., 88.1% of persons with a prescription for Drug A are compliant. Thus, for the Boston area, CI is proportional to (88.3%)/(88.1%) or very close to 1.0. A CI more than 1.0 indicates a greater portion of persons with a prescription are compliant in a particular portion of a region than similar persons in the region as a whole, while a CI less than 1.0 indicates a smaller portion of persons with a prescription are compliant in a particular portion of a region than similar persons in the region as a whole.

The fifth computing platform 150 can determine a group specific CI that compares the compliance rate for persons listed in the persons of interest list 134 stored in the fourth database 108 and the compliance rate for persons in a region or a portion of the region. The group specific CI can be determined for each category and for each pharmaceutical. For example, the fifth computing platform 150 may determine that, for the Boston area, 88.3% of persons with a prescription for Drug A are compliant, and that, for persons on the persons of interest list 134, 82.1% with prescriptions for Drug A are compliant. Thus, the group specific CI is proportional to (82.1%)/(88.1%) or 0.93. A group specific CI more than 1.0 indicates a greater portion of persons in a particular group with a particular prescription are compliant when compared to similar persons in a region or a portion of that region. A group specific CI less than 1.0 indicates a smaller portion of persons in a particular group with a particular prescription are compliant when compared to similar persons in a region or a portion of that region.

The fifth computing platform 150 can determine a value index (VI) that provides a relative value of one portion of a region compared to another portion of the region. The VI is comprised of the TI and the NTBI. The VI can be determined as 50% of the TI summed with 50% of the NTBI. In other embodiments, the relative weights of the TI and NTBI may be different. The VI can be determined for each category of pharmaceuticals and for each pharmaceutical. For example, the fifth computing platform 150 may determine that, for the Boston area, the TI is proportional to 0.89 and the NTBI is proportional to 0.86. Thus, the VI for the Boston area is proportional to 0.5 (0.89)+0.5 (0.86) or 0.88. Because the underlying TI and NTBI were determined with respect to the U.S. as a whole, a VI of less than 1.0 indicates that the Boston area is less than the national average. Similarly, a VI of over 1.0 indicates that the Boston area is exceeding the national average.

The fifth computing platform 150 can determine a group specific VI comprised of the group specific TI and group specific NTBI. The group specific VI can be determined as 50% of the group specific TI summed with 50% of the group specific NTBI. In other embodiments, the relative weights of the group specific TI and group specific NTBI may be different. The group specific VI can be determined for each category of pharmaceuticals and for each pharmaceutical. For example, in the Boston area and for subscribers of a particular cable television provider, the fifth computing platform 150 may determine that the group specific TI is proportional to 0.96 and the group specific NTBI is proportional to 0.94. Thus, the group specific VI is proportional to 0.5 (0.96)+0.5 (0.94) or 0.95. Because the underlying group specific TI and group specific NTBI were determined with respect to the Boston area, a group specific VI of less than 1.0 indicates that this particular group of persons listed on the persons of interest list 134 is underperforming with respect to persons in the Boston area. Similarly, a group specific VI of over 1.0 indicates that the group of persons listed on the persons of interest list 134 is outperforming persons in the Boston area.

The fifth computing platform 150 can determine households or the number of households in the persons of interest list 134 with at least one individual with a prescription for a pharmaceutical or a category of pharmaceuticals. The fifth computing platform 150 can determine a patients per household or the number of patients in each household with at least one person with a prescription for a pharmaceutical or a category of pharmaceuticals of interest. For example, in the U.S., there are 53,000 households formed by the persons on the persons of interest list 134 with a prescription, and 100,000 persons reside in those households. Thus, the patients per household is proportional to 100,000/53,000 or 1.89 patients per household.

The fifth computing platform 150 can determine TRx/household or the number of prescriptions per household with at least one person with a prescription for a pharmaceutical or a category of pharmaceuticals of interest. For example, in the U.S., there are 53,000 households formed by the persons on the persons of interest list 134 with 150,000 prescriptions from patients residing in those households. Thus, the TRx/household is proportional to 150,000/53,000 or 2.83 prescriptions per household.

The fifth computing platform 150 can determine a % household treated or the number of households with a prescription relative to the total number of households. For example, in the U.S. there are 53,000 households formed by the persons on the persons of interest list 134 with a prescription, and 70,000 households with a person on the persons of interest list 134. Thus, the % household treated is proportional to 53,000/70,000 or 0.75 of households had a prescription for a pharmaceutical or category of pharmaceuticals of interest.

In the embodiment shown, the fifth computing platform 150 can store the determinations made with the metrics 136 in the fifth database 110 as the analyzed dataset 130. Thus, the analyzed dataset 130 can include the determined BDI, group specific BDI, CDI, group specific CDI, TRx/patient, TI, group specific TI, NTBI, group specific NTBI, compliance, CI, group specific CI, persistence, VI, group specific VI, patients per household, TRx/household, % household treated, and other similar determinations made with the metrics 136.

The sixth database 112 is in communication with the fifth database 110. The sixth database 112 stores determinations made by the fifth computing platform 150 as reporting data 132. The sixth computing platform 152 is in communication with the sixth database 112. The sixth computing platform 152 can provide a particular determination, some of the determinations, or all of the determinations made by the fifth computing platform 150 in a report 180 with predetermined format or a format determined by the user. The reporting data 132 can store reports 180 analyzing data from different periods of time, so that the reports 180 can be aggregated later or individually analyzed for a particular historical period of time.

In the embodiment shown, the sixth computing platform 152 receives instructions from a user, executes the instructions to form a report 180 from the reporting data 132, and then provides the report 180 to the user. The sixth computing platform 152 can be located near the user and remote from other parts of the system 100. The sixth computing platform 152 preferably communicates with other parts of the system 100 through the internet so that the user can send instructions through a web-based reporting tool. The web-based reporting tool can ask the user for a login and a password to provide more security. Webpages and tabs on the webpages can provide the user with options for the report 180, such as a particular period of time of interest, a particular pharmaceutical of interest, a particular category of pharmaceuticals of interest, a particular portion of a region, a particular gender of patients or persons on the persons of interest list 134, a particular age group of patients or persons on the persons of interest list 134, or some other option for formatting the report 180. The web-based reporting tool can include toolbars, menus, drop down menus, menu options, left or right mouse clicking, or some other input method to receive instructions from the use. The report 180 can be exported to another storage medium in the same or different format. For example, the report 180 can be exported to a spreadsheet program, slide presentation program, or some other program. The user can also sort the data in accordance with one or more particular parameter. In other embodiments, the user can filter the report 180 to limit what is provided in the report 180. The report 180 can be in the form of line items, bar graphs, pie charts, line graph, or some other form of representing data.

The system 100 can be a network configuration or a variety of data communication network environments using software, hardware or a combination of hardware and software to provide the processing functions. All or parts of the system 100 and processes can be stored on or read from computer-readable media. The system 100 can include computer-readable medium having stored thereon machine executable instructions for performing the processes described. Computer readable media may include, for instance, secondary storage devices, such as hard disks, floppy disks, and CD-ROM; or other forms of computer-readable memory such as read-only memory (ROM) or random-access memory (RAM).

Each database 102, 104, 106, 108, 110, and 112 can receive, store, and transmit data 122, 124, 126, 128, 130, and 132, respectively. Also, the number of databases described and shown in the figures is not meant to be limiting to the invention. There may be more or less than the six databases 102, 104, 106, 108, 110, or 112 described herein and depicted in the figures. In some embodiments, two or more of the databases 102, 104, 106, 108, 110, and 112 may be combined in one database. Alternatively, there may be more than six databases 102, 104, 106, 108, 110, and 112. The exact number of databases 102, 104, 106, 108, 110, and 112 depends on, for example, the extent to which the system 100 is geographically dispersed; the storage capacity of each of the databases 102, 104, 106, 108, 110, and 112; and other similar considerations.

Each database 102, 104, 106, 108, 110, and 112 can be a part of, electronically coupled to, or in communication with a computing platform 142, 144, 146, 148, 150, or 152, or can be memory in a computer or processor. Also, the number of computing platforms described and shown in the figures is not meant to be limiting to the invention. There may be more or less than the six computing platforms 142, 144, 146, 148, 150, and 152 described herein and depicted in the figures. In some embodiments, all the computing platforms 142, 144, 146, 148, 150, and 152 may be combined in one. Alternatively, there may be more than six computing platforms 142, 144, 146, 148, 150, and 152. The exact number of computing platforms 142, 144, 146, 148, 150, and 152 depends on, for example, the extent to which the system 100 is geographically dispersed; the processing capacity of each of the computing platforms 142, 144, 146, 148, 150, and 152; the overall processing speed of the system 100; and other similar considerations.

Each computing platform 142, 144, 146, 148, 150, and 152 performs various functions and operations in accordance with the invention. The computing platform 142, 144, 146, 148, 150, and 152 can be, for instance, a personal computer (PC), server or mainframe computer. The computing platform 142, 144, 146, 148, 150, and 152 can be a general purpose computer reconfigured by a computer program, or may be specially constructed to implement the features and operations of the system 100 and/or the method 200. The computing platform 142, 144, 146, 148, 150, and 152 may also be provided with one or more of a wide variety of components or subsystems including, for example, a processor, co-processor, register, data processing devices and subsystems, wired or wireless communication links, input devices, monitors, memory or storage devices such as a database.

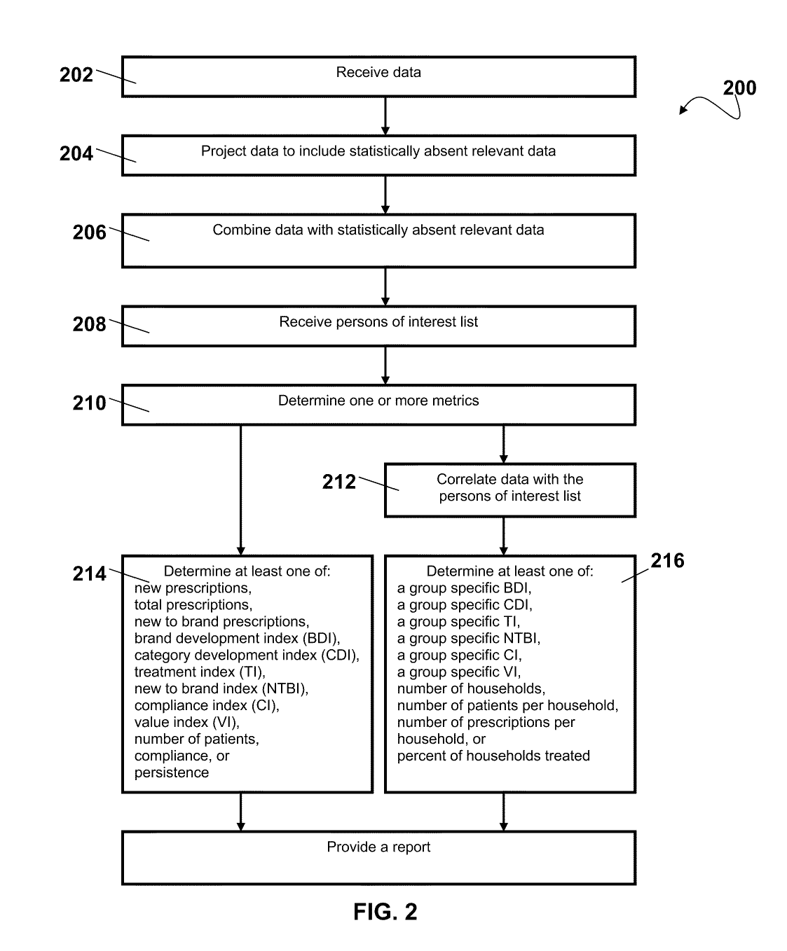

Referring to FIG. 2, a method 200 for providing geographic prescription data is shown to illustrate one embodiment of the invention. Although the method 200 is described as being performed in a certain order of steps, the method 200 can be performed in any suitable manner. The method 200 begins with receiving data, step 202. The data can be non-electronic data 120 or electronic data. Non-electronic data 120 can be converted into electronic raw data 122, manually or automatically, by scanning, character recognition, combinations of the aforementioned, or some other system or method for converting non-electronic data into electronic data. For example, in the embodiment shown, non-electronic claims data can be converted into electronic data. The non-electronic data 120 can be received from several different geographic locations, such as from one or more geographically disparate pharmacies, physician's offices, hospitals, laboratories, health insurers, consultancies, software vendors, clearinghouses, and the like. The non-electronic data 120 can be formatted such that requested information is received in a particular order, in a particular area of a form, or in some other organized manner. The non-electronic data 120 can be converted into electronic raw data 122 after a form has been filled out or as information is provided verbally, by typing, or by writing. The raw data 122 can be stored in accordance with a particular format that is widely used, created specifically for the system 100, or some other acceptable format. Widely used formats include NCPDP 5.1, CMS-1500/837p, CMS-1450/UB-92/UB-40/837i, and other similar formats.

The non-electronic data 120 or electronic raw data 122 can also be de-identified. For example, a computing platform 142 can de-identify the data 120 or 122 with the system and method described in U.S. Patent Appl. Pub. No. 2008/0147554, entitled “System and Method for the De-Identification of Health Care Data,” by Stevens et al. filed on Nov. 27, 2007, which is incorporated herein in its entirety by reference. Because personally identifying information is largely removed from the data 120 or 122, a substitute means of identifying one particular set of data from one particular claim form can be appended. The substitute identification can be a random, unique identifier; an anonymous linking code; a marker, a flag, or something else to signify or describe a particular data or a particular predetermined attribute found in the data 120 or 122. Data 120 or 122 from or regarding the same patient or claimant can be correlated. The data 120 or 122 can also be validated so that the data 120 or 122 is correctly formatted or not electronically corrupted.

A condensed, more relevant portion of the data 120 or 122 can be extracted to form a partial raw data 124. The partial raw data 124 may include only data 120 or 122 from a particular type of data 120, such as from prescription claims; non-electronic data 120 with a particular entry in a data field, such as a particular location; non-electronic data 120 from a particular time period, such as within the last month; or some other criteria that segregates more relevant raw data 122 from other raw data 122. In other embodiments, substantially all of the data 120 or 122 may constitute the partial raw data 124.

The data 120, 122, or 124 is then projected to include statistically absent relevant data, step 204. Such absent relevant data may arise due to errors in collecting, storing, or otherwise handling the electronic healthcare data. For example, the partial raw data 124 can be analyzed to determine statistically absent relevant data or erroneous data. Due to errors in collecting, storing, or otherwise handling data 120 or 122, there may be some non-electronic data 120 that was not collected or erroneously collected. Thus, a computing platform 144, for example, can verify data integrity or provide data validation. There may be an omitted value in the non-electronic data 120. A reasonable value for the omitted value based on reference data, interpolation based on other historic data, or some other source of reasonable data can be inserted for the omitted value. For instance, if the quantity for a particular pharmaceutical was omitted, a search based on the NCD11, an industry standard product identification number, associated with the pharmaceutical can be conducted and find that the pharmaceutical is available only in a certain unit size that cannot be subdivided into smaller units. Thereafter, that size can be inserted for the omitted quantity value. In another example, one particular value in the data 120 or 122 may be outside a reasonable range, and a more suitable value within the expected range can be substituted.

Thereafter, substitute values for omitted or erroneous data can be combined with the data 120, 122, or 124, step 206. Furthermore, the partial raw data 124 can be further organized into a dataset 126. If there are more than one set of partial raw data 124, the several partial raw data 124 can be organized into a more convenient single dataset 126, such as by a computing platform 146.

A persons of interest list 134 is received, step 208. The persons of interest list 134 can be a list of clients, customers, consumers, subscribers, or some other predetermined group of persons. The persons of interest list 134 can be provided by a user, such as a researcher, a marketer, a subscription service provider, or some other entity that is interested in examining a certain group of persons or examining persons in a particular portion of a region. The persons of interest list 134 can then be used to correlate data 120, 122, 124, or 126 to any individual listed in the persons of interest list 134. The data 120, 122, 124, or 126 can be filtered with the persons of interest list 134 to identify data 120, 122, 124, or 126 related to a particular person on the persons of interest list 134. The data 120, 122, 124, or 126 can also be analyzed to acquire the occurrence of certain characteristics in the data 120, 122, 124, or 126. For instance, the data 120, 122, 124, or 126 can be analyzed to find if any individual listed on the persons of interest list 134 is connected with a particular brand of pharmaceuticals, whether the particular brand is branded or generic, the category within which the particular brand belongs, the age of the person prescribed the pharmaceutical, the gender of the person prescribed the pharmaceutical, and other similar information. A computing platform 148 can receive the persons of interest list 134 manually or electronically and correlate the persons of interest list 134 with the data 120, 122, 124, or 126.

One or more metrics 136 can also be determined, step 210. The one or more metrics can be based on geography, such as those used by marketers, which divides the United States into markets or areas around major metropolitan areas. Metrics 136 for new prescriptions, total prescriptions, new to brand prescriptions, brand development index (BDI), category development index (CDI), treatment index (TI), new to brand index (NTBI), compliance index (CI), value index (VI), number of patients, compliance, or persistence can be determined from the data 120, 122, 124, 126, or 128, step 212. The metrics 136 can be determined by a computing platform 142, 144, 146, 148 or 150.

The data 120, 122, 124, 126, or 128 can be correlated with the persons of interest list 134, step 212. By correlating the data 120, 122, 124, 126, or 128 with the persons of interest list 134, a group specific BDI, a group specific CDI, a group specific TI, a group specific NTBI, a group specific CI, group specific VI, number of households, number of patients per household, number of prescriptions per household, or percent of households treated can be calculated from correlating the electronic healthcare data with the persons of interest list can be determined, step 216. Then, a report may be formed from the above determinations, step 218.

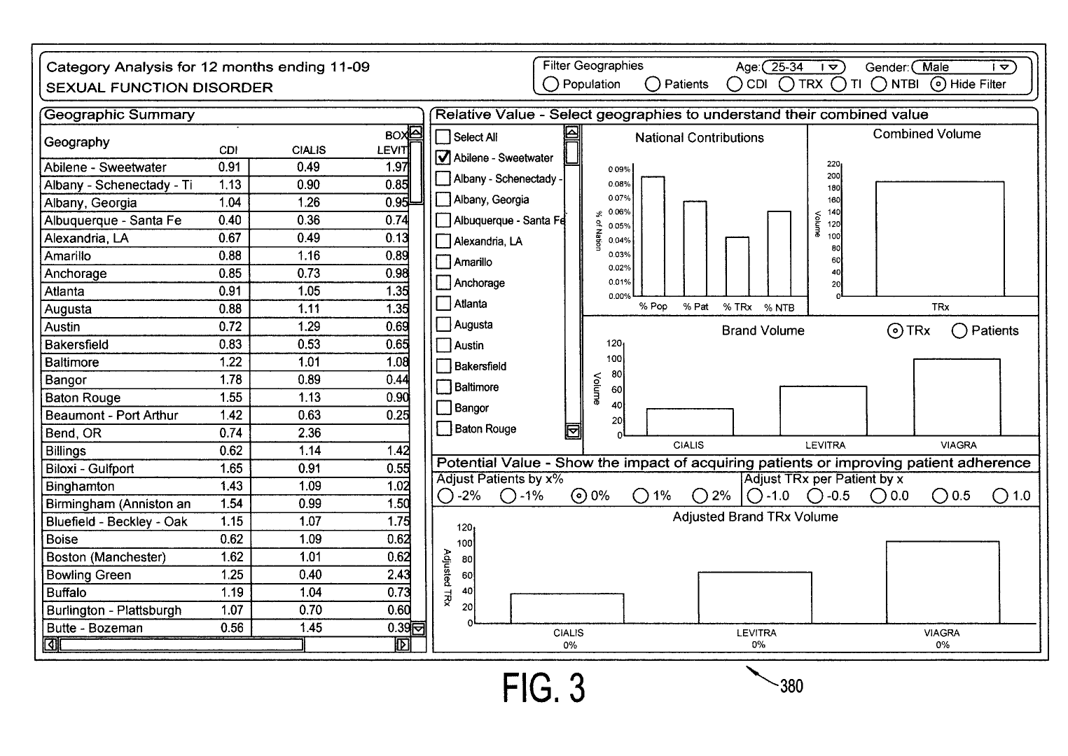

Referring to FIG. 3, an example of a report 380 provided by the system 100 and the method 200 is shown. The report 380 includes information regarding a particular category of pharmaceuticals. In embodiment shown, the category of pharmaceuticals is “sexual function disorder.” The information is further organized by portions of a region, and in the figure, the portions of a region are areas around certain cities and towns. For each portion of the region, its category development index or CDI is listed. CDI provides a value that compares the population in a portion of a region being treated by a pharmaceutical in a particular category to the whole population in the whole region being treated by a pharmaceutical in the same category.

The invention breaks down the filtered information (in this case, the category “sexual function disorder,” sex “male,” and age “25-34”) into respective geographic regions having responsive information. Any regions which do not have any men aged 25-34 with a sexual function disorder is not shown, though alternatively can be listed as zero. Alternatively, the regions can be predefined regions or regions which are selected by the user. In filtering the data, the system 100 or the method 200 determines the appropriate region for each data set based on the city, state, and/or zip code fields for that data set. The system 100 or the method 200 can also assign a predefined region to each data set as that data is entered into the database 102. Information about several regions can be amalgamated, and then the combined information can be displayed in the report 380. Alternatively, information about a particular region or portion of a region can be further granulated to distill information regarding a smaller portion of the region or a portion thereof. For example, in the example report 380 shown, the report 380 provides information about the Abilene-Sweetwater area in comparison with the United States. In other embodiments, the system 100 and the method 200 can provide information regarding the United States, a particular state, metropolitan area, county, city, suburb, zip code, or some other division of a region. Also, in other embodiments, the system 100 and the method 200 can provide a comparison between one or more states, metropolitan areas, counties, cities, suburbs, zip codes, or some other divisions of a region. For example, the report 380 can compare Abilene-Sweetwater with Baltimore, an area within Abilene-Sweetwater with the state of Texas, or some other combination of states, metropolitan areas, counties, cities, suburbs, zip codes, or some other divisions of a region.

Accordingly, as shown in the report 380 of FIG. 3, the various available geographic regions are displayed in the summary section, with the associated CDI and BDI. The user can select to obtain further detailed information about a desired region. For the example report 380 in the figure, the user has selected to display further information about Abilene-Sweetwater (listed near the top left of the report 380). In particular, the report 380 provides information regarding the portion of the population of Abilene-Sweetwater being treated with a pharmaceutical in the sexual function disorder category. The population is further filtered for males between the ages of 25-34, as shown in the upper right of the report 380, next to “Filter Geographies.” For Abilene-Sweetwater, its CDI for the sexual function disorder category is shown as 0.91. Also, the information displayed for Abilene-Sweetwater is for a 12-month period ending in November 2009, as indicated in the upper left of the report 380. The user can specify a particular period of time of interest at, for example, the sixth computing platform 152. Then, the sixth computing platform 152 can gather relevant information for that period of time from the reporting data 132 stored at the sixth database 112 and provide a report 380. Also, the information in columns, such as the CDI or BDI, can be sorted so, for example, the information in that column can be displayed from the highest value down to the lowest value.

Immediately below “Filter Geographies” are radio buttons labeled “Population,” “Patient,” “CDI,” “TRX,” “TI,” “NTBI,” and “Hide Filter.” Selecting “Population,” “Patient,” “CDI,” “TRX,” “TI,” or “NTBI” causes a pop up box to be displayed. The pop up box provides information filtered by the selected metric population, patient, CDI, TRx, TI, or NTBI. After the information is filtered by population, patient, CDI, TRx, TI, or NTBI, the pop up box provides the regions or portions of region that have the highest population, patient, CDI, TRx, TI, or NTBI. In some embodiments, the pop up box may provide all the portions in a region that fall within the top 5%, 10%, 25%, 50%, or 75% of population, patient, CDI, TRx, TI, or NTBI. In other embodiments, instead of a pop up box, a portion of the report 380 may be substituted or cause another report to be provided. In the report 380 shown in FIG. 3, “Hide Filter” is selected so there is no pop up box.

The report 380 has three display sections: Geography Summary, Relative Value, and Potential Value. Further information regarding the desired geographic region (i.e., Abilene-Sweetwater) is shown to the right of the report 380. The Relative Value section includes a “National Contribution” bar graph in the upper right. That graph includes the population of Abilene-Sweetwater as a percentage of the total U.S. population, the percentage of total U.S. patients of the category which are in the Abilene-Sweetwater area, the percentage of the total U.S. prescriptions in Abilene-Sweetwater, and the percentage of new prescriptions in Abilene-Sweetwater. The total U.S. population and the population of Abilene-Sweetwater can be a part of the patient level dataset 128 stored in the fourth database 108.

The Relative Value section also has a “Combined Volume” bar graph. That graph shows the total number of prescriptions and displays the total as “volume.” The fourth computing platform 148 or step 214 of the method 200 can determine the total prescriptions TRx for a particular pharmaceutical or a particular category of pharmaceuticals and store the values in the patient level dataset 128. Then, the total prescriptions for a category of pharmaceuticals from the patient level dataset 128 can be displayed in a report 380.

The Relative Value section also has a “Brand Volume” bar graph which shows the total prescriptions for particular pharmaceuticals in the sexual function disorder category. The “Brand Volume” can be toggled to show the total number of patients for each particular pharmaceutical, instead of by total prescriptions. The fourth computing platform 148 or step 214 of the method 200 can determine the total prescriptions TRx for a particular pharmaceutical. The fourth computing platform 148 or step 214 can also determine the number of patients filling a prescription for a particular pharmaceutical. Thus, the total number of prescriptions for a particular pharmaceutical can be displayed when the “TRx” button is toggled, or the number of patients prescribed a particular pharmaceutical can be displayed when the “Patients” button is toggled.

The “Potential Value” section has an “Adjusted Brand TRx Volume” bar graph, which shows the impact of acquiring new patients or improving patient adherence for particular pharmaceuticals in the sexual function disorder category. The “Potential Value” graphically shows the changes in total prescriptions for a particular category of pharmaceuticals in the Abilene-Sweetwater area because of an increase or decrease in patients or total prescriptions per patient. The fourth computing platform 148 or step 214 can determine total prescriptions and total prescriptions per patient for a particular pharmaceutical, and thus the fourth computing platform 148 or step 214 can adjust the determination by a desired amount and provide the data for the report 380. In the embodiment shown, the total prescriptions for Cialis, Levitra, and Viagra for male patients, ages 25-34, in the Sweetwater-Abilene region are shown. As shown by the toggles immediately above the graph, the number of patients and the total prescriptions per patient have been adjusted by 0% and 0.0, respectively (i.e., the number of patents and total prescriptions per patient are shown unadjusted). If the user wishes to see the changes resulting from an increase or decrease in patients, the user can toggle the −2%, −1%, 1%, or 2% buttons. After toggling one of these buttons, the total number of prescriptions for Cialis, Levitra, and Viagra for male patients, ages 25-34, in the Sweetwater-Abilene region will be adjusted for a −2%, −1%, +1%, or +2% change in the number of patients. Similarly, if the user wishes to see the changes resulting from an increase or decrease in the total prescriptions per patient, the user can toggle the −1.0, −0.5, 0.5, or 1.0 buttons. After toggling one of these buttons, the total number of prescriptions for Cialis, Levitra, and Viagra for male patients, ages 25-34, in the Sweetwater-Abilene region will be adjusted for a rise or drop of 1.0 or 0.5 in the total prescriptions per patient. A user, such as a marketer, may determine that an increase in patients or total prescriptions per patient for a particular pharmaceutical may result in a significant change in total prescriptions for that particular pharmaceutical, thus significantly increasing sales of that pharmaceutical. The marketer may then decide to increase marketing resources for that particular pharmaceutical or determine that marketing resources are optimally expended for that particular pharmaceutical. Although, in the embodiment shown, the buttons only affect the “Potential Value” graph, in other embodiments, the buttons may affect the “National Contribution,” “Combined Volume,” “Brand Volume,” or some combination of those graphs.

The report 380 allows a user to graphically see information for a particular category of pharmaceuticals prescribed for a particular group of patients in a particular region. The user may adjust the report 380 to view information regarding other categories of pharmaceuticals, other groups of patients (such as patients in other age groups or different gender), and other regions. For a particular category of pharmaceuticals, the report 380 can provide the population, patients, total prescriptions, and new to brand prescriptions for that category of pharmaceuticals. The report 380 can also provide further information for particular pharmaceuticals in the category and show the effects of increasing the number of patients or prescriptions per patient. The report 380 can use bar graphs to quickly convey the information visually. In other embodiments of the report 380, instead of bar graphs, similar information may be displayed numerically, or in a pie chart, line graph, or some other visual representation of information. Thus, the user can quickly determine the predominance of a particular category of pharmaceuticals or a particular pharmaceutical for a region in relation to other regions and determine the effect of increasing that predominance. Therefore, a user, such as a marketer, can determine the present effectiveness of marketing by examining the present volume of prescriptions and the impact of increasing marketing resources by examining an increase in patients or prescriptions per patient.

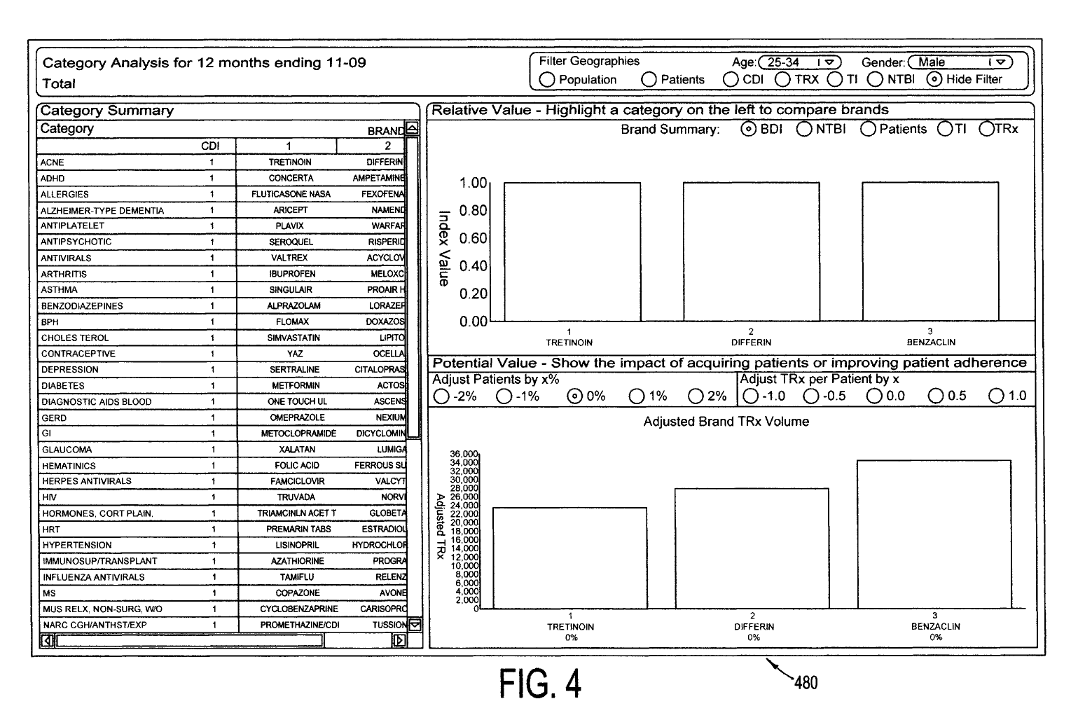

Referring to FIG. 4, an example of a report 480 provided by the system 100 or the method 200 is shown. Unlike the report 380 shown in FIG. 3 that provides information for a particular portion of a region or a region, the report 480 provides information for a particular category of pharmaceuticals. The information displayed is for a 12-month period ending in November 2009, as indicated in the upper left of the report 480. The user can specify a particular period of time of interest at, for example, the sixth computing platform 152. Then, the sixth computing platform 152 can gather relevant information for that period of time from the reporting data 132 stored at the sixth database 112 and provide the report 480. The information is organized by categories of pharmaceuticals (listed in the left side of the report 480). For each category of pharmaceuticals, its category development index or CDI is listed, and particular pharmaceuticals in the category are listed. In the embodiment shown, information for the region as a whole is shown, so the values for CDI are all “1.” More detailed information regarding the selected category, acne, is provided in the right side of the report 480. For each pharmaceutical shown, its brand development index or BDI is graphically shown as a bar graph (the “Relative Value” graph in the upper right of the figure). The BDI provides a measurement of the popularity of a particular pharmaceutical in a particular portion of a region compared to its popularity in the region as a whole. The graph can also be modified to display the NTBI, patients, TI, or TRx for particular pharmaceuticals. The fourth computing platform 108 or step 214 can provide the patients and TRx. The fifth computing platform 110 or step 214 can provide the CDI, BDI, NTBI, and TI.

Also, the report 480 shows as a bar graph (the “Potential Value” graph in lower right of the figure) for the total prescriptions for particular pharmaceuticals in the acne category. The “Potential Value” graphically shows the changes in total prescriptions for a particular category of pharmaceuticals because of an increase or decrease in patients or total prescriptions per patient. The fourth computing platform 148 or step 214 can determine total prescriptions and total prescriptions per patient for a particular pharmaceutical, and thus the fourth computing platform 148 or step 214 can adjust the determination by a desired amount and provide the data for the report 480. In the embodiment shown, the total prescriptions for Tretinoin, Differin, and Benzaclin for male patients, ages 25-34, are shown. As shown by the toggles immediately above the graph, the number of patients and the total prescriptions per patient have been adjusted by 0% and 0.0, respectively (i.e., the number of patents and total prescriptions per patient are shown unadjusted). If the user wishes to see the changes resulting from an increase or decrease in patients, the user can toggle the −2%, −1%, 1%, or 2% buttons. After toggling one of these buttons, the total number of prescriptions for Tretinoin, Differin, and Benzaclin for male patients, ages 25-34, will be adjusted for a −2%, −1%, +1%, or +2% change in the number of patients. Similarly, if the user wishes to see the changes resulting from an increase or decrease in the total prescriptions per patient, the user can toggle the −1.0, −0.5, 0.5, or 1.0 buttons. After toggling one of these buttons, the total number of prescriptions for Tretinoin, Differin, and Benzaclin for male patients, ages 25-34, will be adjusted for a rise or drop of 1.0 or 0.5 in the total prescriptions per patient. A user, such as a marketer, may determine that an increase in patients or total prescriptions per patient for a particular pharmaceutical may result in a significant change in total prescriptions for that particular pharmaceutical, thus significantly increasing sales of that pharmaceutical.

The report 480 allows a user to graphically see information for a particular category of pharmaceuticals prescribed for a particular group of patients. The user may adjust the report 480 to view information regarding other categories of pharmaceuticals and other groups of patients (such as patients in other age groups or different gender). For a particular category of pharmaceuticals, the report 480 can provide the BDI, NTBI, patients, TI, and total prescriptions for particular pharmaceuticals in that category. The report 480 can also show the effects of increasing the number of patients or prescriptions per patient. The report 480 can use bar graphs to quickly convey the information visually. In other embodiments of the report 380, instead of bar graphs, similar information may be displayed numerically, or in a pie chart, line graph, or some other visual representation of information. Unlike the report 380 shown in FIG. 3, the report 480 provides more information about particular pharmaceuticals in a category relative to other pharmaceuticals in the category. Thus, the user can quickly determine the predominance of a particular pharmaceutical and determine the effect of increasing that predominance. Therefore, a user, such as a marketer, can determine the present effectiveness of marketing by examining the present volume of prescriptions and the impact of increasing marketing resources by examining an increase in patients or prescriptions per patient.

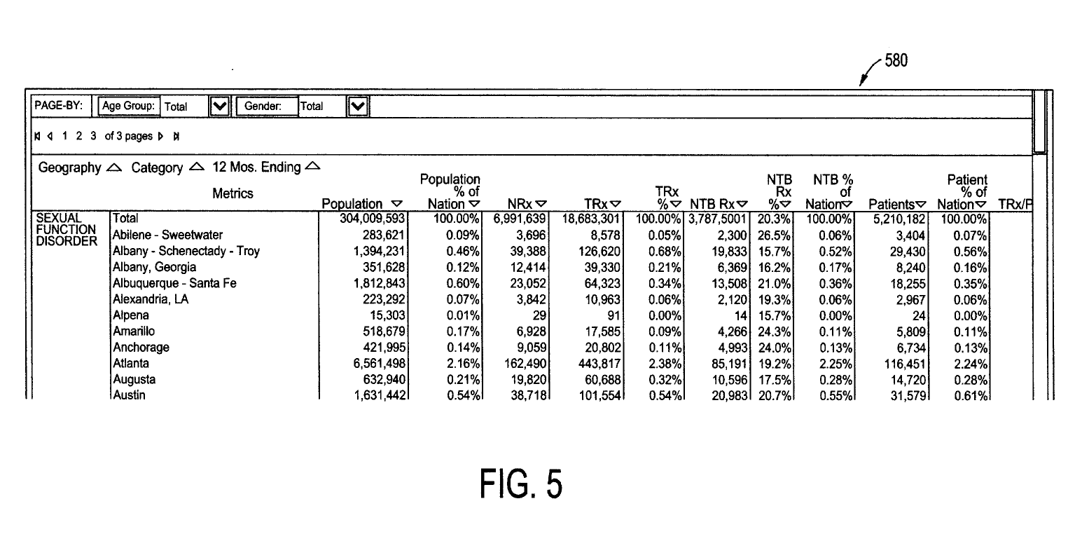

Referring to FIG. 5, a portion of an example report 580 provided by the system 100 or method 200 is shown. The report 580 includes information regarding a particular category of pharmaceuticals. The information displayed is for a 12-month period, as indicated in the upper left of the report 580. The user can specify a particular period of time of interest at, for example, the sixth computing platform 152. Then, the sixth computing platform 152 can gather relevant information for that period of time from the reporting data 132 stored at the sixth database 112 and provide the report 580. In the report 580 shown, the category of pharmaceuticals is sexual function disorder. The information is further organized by portions of a region, and in the figure, the portions of a region are areas around certain cities and towns. For each portion of the region, its population (Population), its percentage of U.S. population (Population % of Nation), its new prescriptions (NRx), its total prescriptions (TRx), its percentage of total prescriptions (TRx %), its new to brand prescriptions (NTB Rx), its percentage of new to brand prescriptions (NTB Rx %), its number of patients (Patients), and its patients as a percentage of total patients in the nation (Patient % of Nation), each listed in columns. In other embodiments, report 580 may include BDI or a group specific BDI. Also, the information in each column can be sorted so, for example, the information in a particular column can be displayed from the highest value down to the lowest value. The fourth computing platform 148, the fifth computing platform 150, or step 214 can provide the values displayed in report 580. As indicated in the upper part of the report 580, patients include male and female patients in all age categories. A user can select a particular age group or select and view data for just male or female patients. Thus, for example, the TRx % for Abilene-Sweetwater in the Sexual Function Disorder category is 0.05% for all patients in all age groups and for both genders, as shown in FIG. 5, but for male patients for ages 25-34, the TRx % is about 0.04%, as shown in the “National Contribution” graph in FIG. 3.

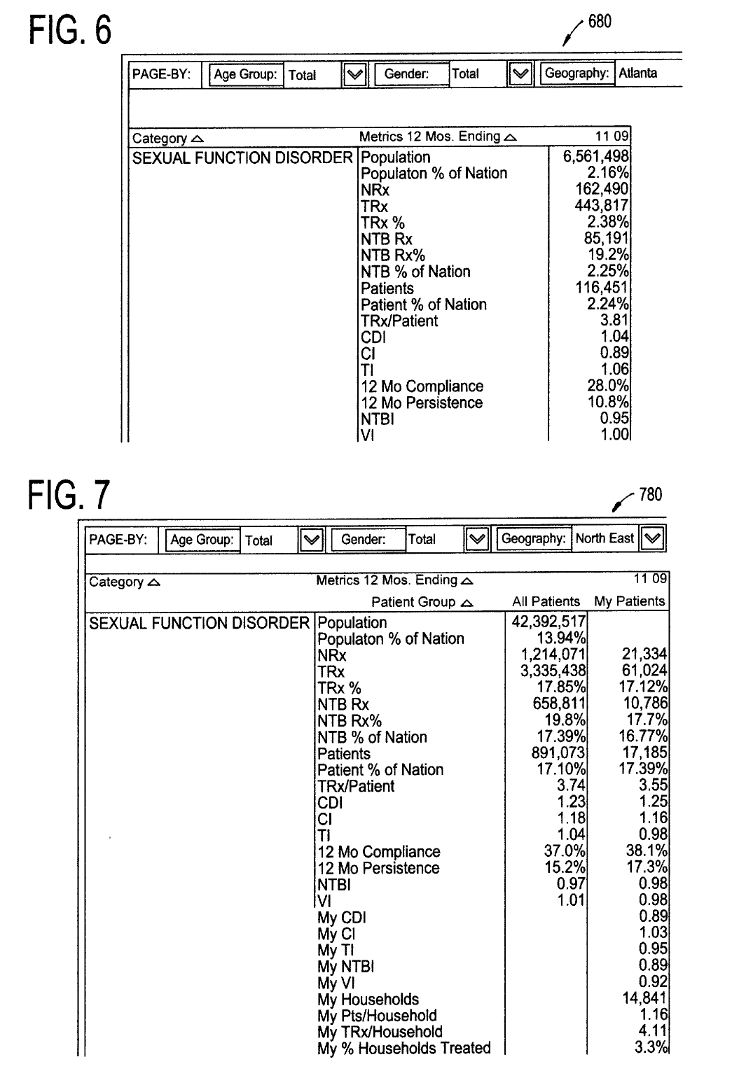

Referring to FIG. 6, a portion of an example report 680 provided by the system 100 or method 200 is shown. The report 680 provides information about one category of pharmaceuticals. The information displayed is for a 12-month period ending in November 2009, as indicated in the upper left of the report 680. The user can specify a particular period of time of interest at, for example, the sixth computing platform 152. Then, the sixth computing platform 152 can gather relevant information for that period of time from the reporting data 132 stored at the sixth database 112 and provide the report 680. In the report 680 shown, the selected category is sexual function disorder. The report 680 lists population (Population), percentage of U.S. population (Population % of Nation), new prescriptions (NRx), total prescriptions (TRx), percentage of total prescriptions (TRx %), new to brand prescriptions (NTB Rx), percentage of new to brand prescriptions (NTB Rx %), number of patients (Patients), patients as a percentage of total patients in the nation (Patient % of Nation), total prescriptions per patient (TRx/Patient), category development index (CDI), compliance index (CI), treatment index (TI), twelve month compliance, twelve month persistence, new to brand index (NTBI), and value index (VI) for one particular category of pharmaceuticals. The fourth computing platform 148, the fifth computing platform 150, or step 214 can provide the values displayed in report 680. As shown in the upper part of the report 680, the information encompasses male and female patients in all age categories in the Atlanta area. A user can select other age groups, select and view data for male or female patients, or select and view data for another portion of a region.

Turning to FIG. 7, a portion of an example report 780 provided by the system 100 or the method 200 is shown. However, unlike report 680, report 780 provides information about a particular category of pharmaceuticals for an area larger than the area of report 680. In particular, the report 780 provides information about the North East, and not just the Atlanta area as in the report 680. The information displayed is for a 12-month period ending in November 2009, as indicated in the upper left of the report 780. The user can specify a particular period of time of interest at, for example, the sixth computing platform 152. Then, the sixth computing platform 152 can gather relevant information for that period of time from the reporting data 132 stored at the sixth database 112 and provide the report 780. In the report 780 shown, the report 780 provides information about pharmaceuticals in the sexual function disorder category for the North East. Similar to report 680, the report 780 lists population (Population), percentage of U.S. population (Population % of Nation), new prescriptions (NRx), total prescriptions (TRx), percentage of total prescriptions (TRx %), new to brand prescriptions (NTB Rx), percentage of new to brand prescriptions (NTB Rx %), number of patients (Patients), patients as a percentage of total patients in the nation (Patient % of Nation), total prescriptions per patient (TRx/Patient), category development index (CDI), compliance index (CI), treatment index (TI), twelve month compliance, twelve month persistence, new to brand index (NTBI), and value index (VI) for the category of sexual function disorder. However, the report 780 also includes a group specific CDI (My CDI), a group specific CI (My CI), a group specific TI (My TI), a group specific NTBI (My NTBI), a group specific VI (My VI), a group specific households (My households), a group specific patients per household (My Pts/Household), a group specific total prescriptions per household (My TRx/Household), and a group specific percentage of households being treated (My % Households Treated). The fourth computing platform 148, the fifth computing platform 150, or step 214 can provide the values displayed in report 780. The above listed information is provided in terms of all patients and for patients on the persons of interest list 134, as shown in the upper part of the report 780. A user can select other age groups, select and view data for male or female patients, or select and view data for another portion of a region.

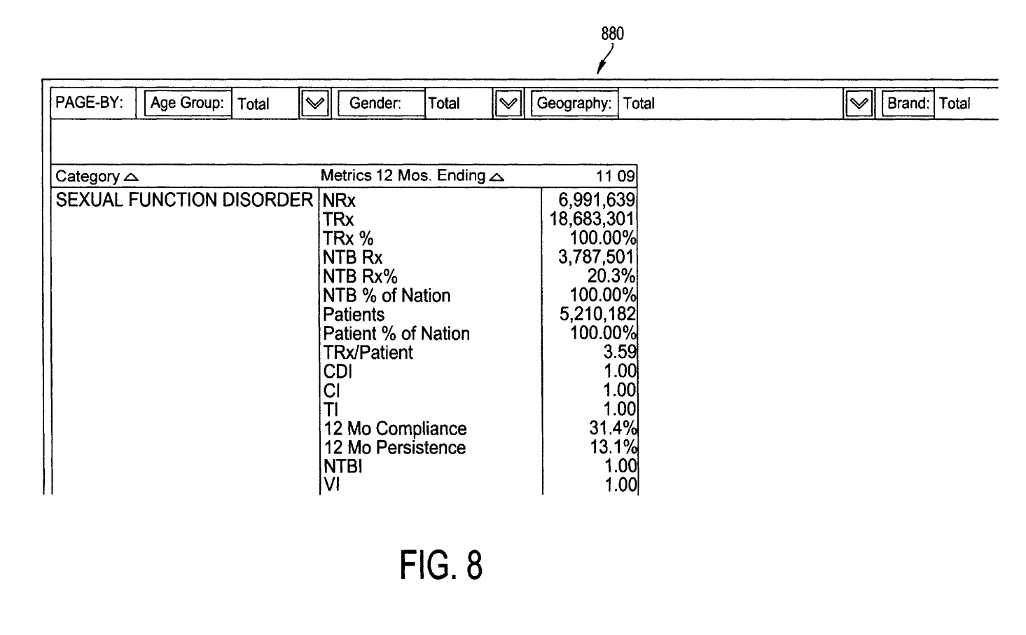

Referring to FIG. 8, a portion of an example report 880 similar to reports 680 and 780 is shown. However, unlike reports 680 and 780, report 880 provides information about a particular category of pharmaceuticals for an entire region, as shown in the upper part of report 880 (the selected geography is “Total” or the United States). The information displayed is for a 12-month period ending in November 2009, as indicated in the upper left of the report 880. The user can specify a particular period of time of interest at, for example, the sixth computing platform 152. Then, the sixth computing platform 152 can gather relevant information for that period of time from the reporting data 132 stored at the sixth database 112 and provide the report 880. As with reports 680 and 780, a user can select other age groups, retrieve and view data for male or female patients, or retrieve and view data for another portion of a region. In the report 880 shown, the report 880 provides information about pharmaceuticals in the sexual function disorder category for the United States. Similar to reports 680 and 780, the report 880 lists new prescriptions (NRx), total prescriptions (TRx), percentage of total prescriptions (TRx %), new to brand prescriptions (NTB Rx), percentage of new to brand prescriptions (NTB Rx %), number of patients (Patients), patients as a percentage of total patients in the nation (Patient % of Nation), total prescriptions per patient (TRx/Patient), compliance index (CI), treatment index (TI), twelve month compliance, twelve month persistence, new to brand index (NTBI), and value index (VI) for the category of sexual function disorder. Additionally, report 880 includes new to brand prescriptions as a percentage of total prescriptions in the nation (NTB % of Nation) and brand development index (BDI). The fourth computing platform 148, the fifth computing platform 150, or step 214 can provide the values displayed in report 880. The above listed information is provided for all age groups, for both genders, for the “Total” region, and for all brands or pharmaceuticals in the category, as shown in the upper part of the report 880. A user can select and view another age group, select and view data for male or female patients, select and view data for another portion of a region, or select and view data for a particular pharmaceutical in the category.

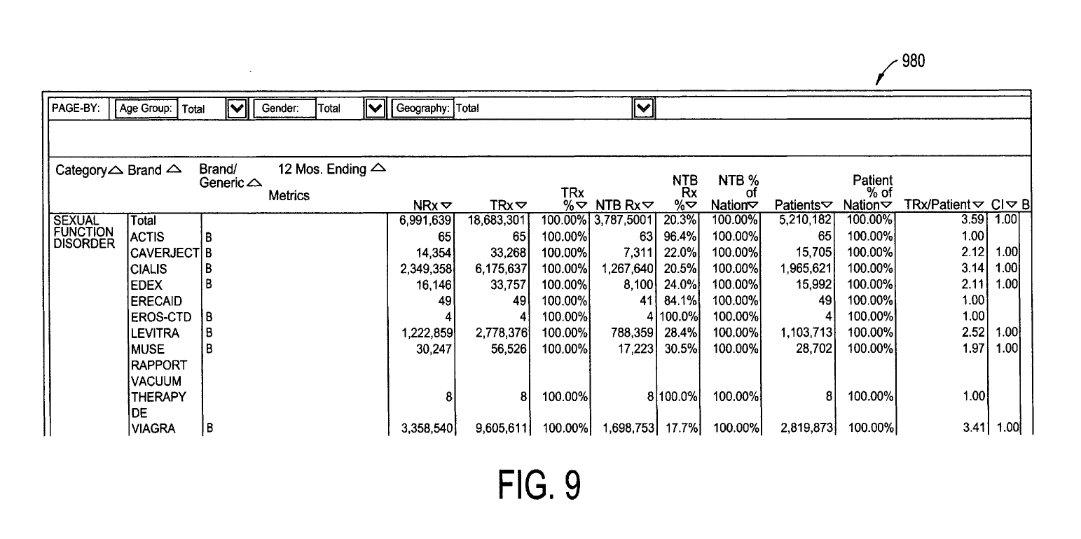

Referring to FIG. 9, an example report 980 provided by system 100 or method 200 is shown. The report 980 is similar to report 580, except that report 980 provides information for each pharmaceutical in the category instead providing information about each portion of a region for a particular category of pharmaceuticals. In the report 980 shown, the category of pharmaceuticals is sexual function disorder. The information is further organized by pharmaceuticals in that category. The information displayed is for a 12-month period ending in November 2009, as indicated in the upper left of the report 980. The user can specify a particular period of time of interest at, for example, the sixth computing platform 152. Then, the sixth computing platform 152 can gather relevant information for that period of time from the reporting data 132 stored at the sixth database 112 and provide the report 980. Similar to report 580, for each pharmaceutical in the category, the report 980 provides its population (Population), its percentage of U.S. population (Population % of Nation), its new prescriptions (NRx), its total prescriptions (TRx), its percentage of total prescriptions (TRx %), its new to brand prescriptions (NTB Rx), its percentage of new to brand prescriptions (NTB Rx %), its number of patients (Patients), and its patients as a percentage of total patients in the nation (Patient % of Nation), each listed in columns. The fourth computing platform 148, the fifth computing platform 150, or step 214 can provide the values displayed in report 980. Also, the information in each column can be sorted so, for example, the information in a particular column can be displayed from the highest value down to the lowest value. As indicated in the upper part of the report 980, patients include male and female patients in all age categories. A user can select other age groups, select and view data for male or female patients, or select and view data for another portion of a region.

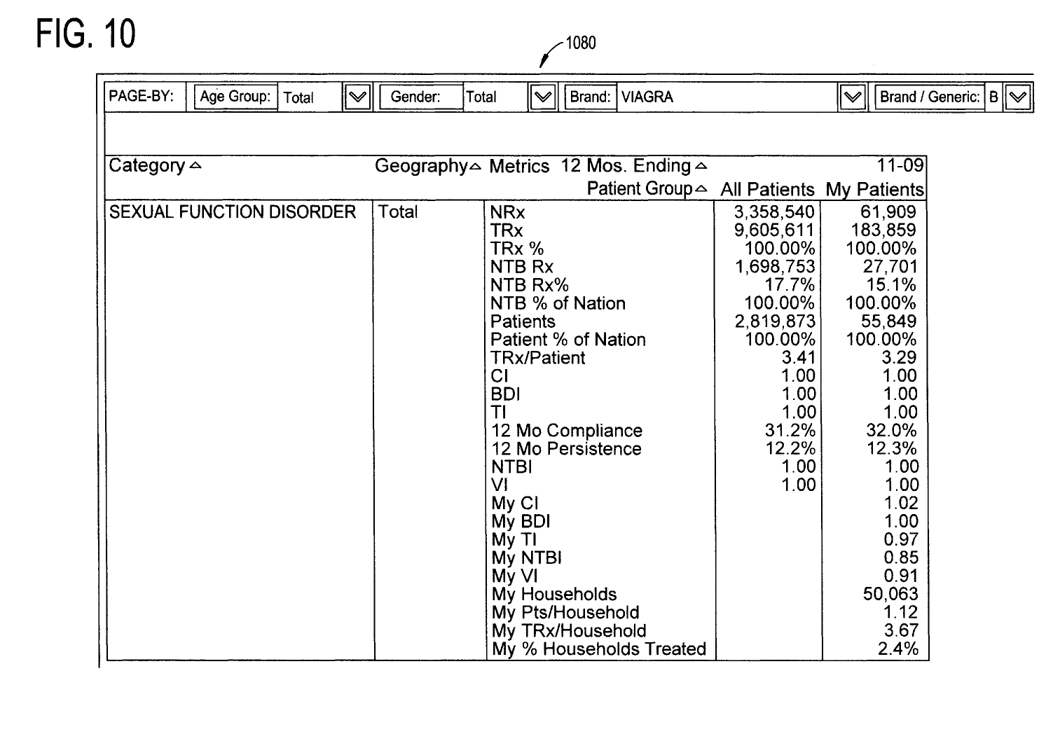

Referring to FIG. 10, a portion of an example report 1080 provided by system 100 or method 200 is shown. The report 1080 provides information regarding a particular pharmaceutical. The information displayed is for a 12-month period ending in November 2009, as indicated in the upper left of the report 1080. The user can specify a particular period of time of interest at, for example, the sixth computing platform 152. Then, the sixth computing platform 152 can gather relevant information for that period of time from the reporting data 132 stored at the sixth database 112 and provide the report 1080. In the example shown, the report 1080 provides information about Viagra for male and female patients in all age categories. For a particular pharmaceutical, the report 1080 provides new prescriptions (NRx), total prescriptions (TRx), percentage of total prescriptions (TRx %), new to brand prescriptions (NTB Rx), percentage of new to brand prescriptions (NTB Rx %), number of patients (Patients), patients as a percentage of total patients in the nation (Patient % of Nation), total prescriptions per patient (TRx/Patient), category development index (CDI), compliance index (CI), treatment index (TI), twelve month compliance, twelve month persistence, new to brand index (NTBI), and value index (VI) for the category of sexual function disorder. However, the report 1080 also includes a group specific CDI (My CDI), a group specific CI (My CI), a group specific TI (My TI), a group specific NTBI (My NTBI), a group specific VI (My VI), a group specific households (My households), a group specific patients per household (My Pts/Household), a group specific total prescriptions per household (My TRx/Household), and a group specific percentage of households being treated (My % Households Treated). The above listed information is provided in terms of all patients and for patients on the persons of interest list 134. The fourth computing platform 148, the fifth computing platform 150, or step 214 can provide the values displayed in report 1080. A user can select other age groups, select and view data for male or female patients, select and view data for another particular pharmaceutical, or select and view data for the brand name or generic version of that particular pharmaceutical (selected through the “Brand/Generic” menu).

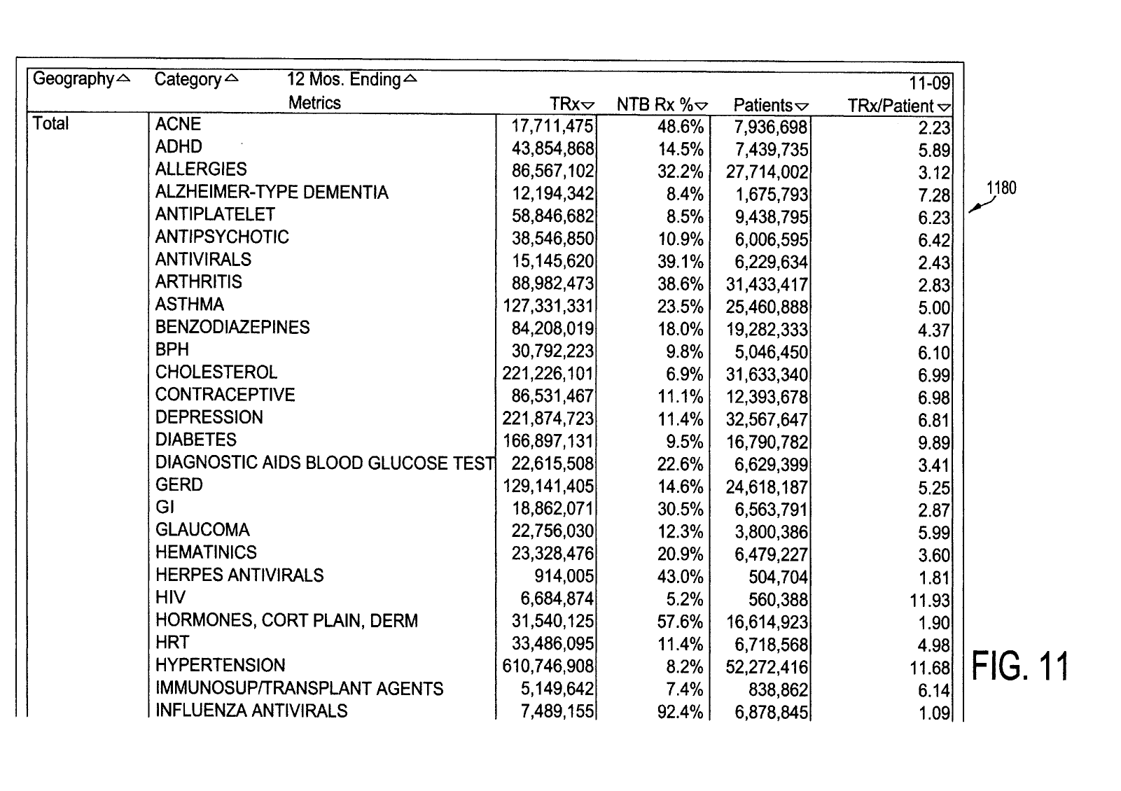

Referring to FIG. 11, a portion of an example report 1180 provided by system 100 or method 200 is shown. The report 1180 provides information for an entire region regarding each category of pharmaceuticals. The information displayed is for a 12-month period ending in November 2009, as indicated in the upper left of the report 1180. The user can specify a particular period of time of interest at, for example, the sixth computing platform 152. Then, the sixth computing platform 152 can gather relevant information for that period of time from the reporting data 132 stored at the sixth database 112 and provide the report 1180. In the report 1180 shown, the report 1180 provides information for the U.S. because the selected geography is “Total” and for each category of pharmaceuticals. The report 1180 provides total prescriptions (TRx), percentage of new to brand prescriptions (NTB Rx %), number of patients (Patients), and total prescriptions per patient (TRx/Patient), each listed in columns. The information in each column can be sorted so, for example, the information in a particular column can be displayed from the highest value down to the lowest value. The fourth computing platform 148, the fifth computing platform 150, or step 214 can provide the values displayed in report 1180.

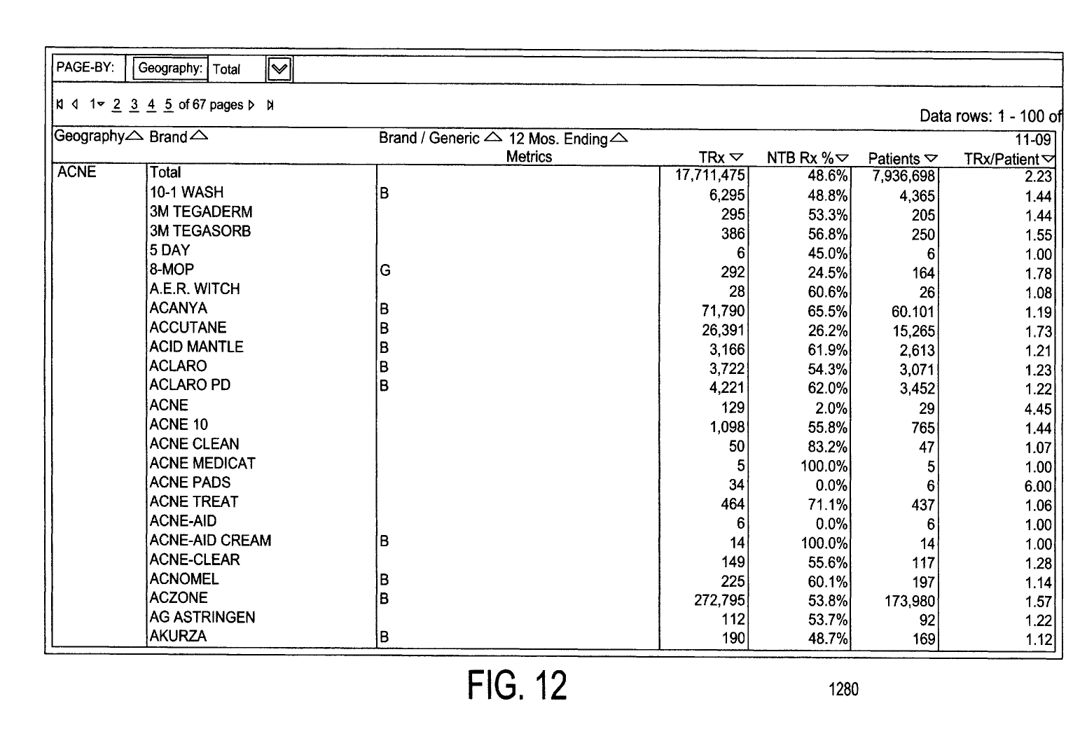

Referring to FIG. 12, a portion of an example report 1280 provided by system 100 or method 200 is shown. The report 1280 provides information for each pharmaceutical in a particular category of pharmaceuticals. The information displayed is for a 12-month period ending in November 2009, as indicated in the upper left of the report 1280 and for the entire United States (the selected geography is “Total”). The user can specify a particular period of time of interest at, for example, the sixth computing platform 152. Then, the sixth computing platform 152 can gather relevant information for that period of time from the reporting data 132 stored at the sixth database 112 and provide the report 1280. In the report 1280 shown, the report 1280 lists each pharmaceutical in the category, and for each pharmaceutical, the report 1280 provides total prescriptions (TRx), percentage of new to brand prescriptions (NTB Rx %), number of patients (Patients), and total prescriptions per patient (TRx/Patient), each listed in columns. The information in each column can be sorted so, for example, the information in a particular column can be displayed from the highest value down to the lowest value. The fourth computing platform 148, the fifth computing platform 150, or step 214 can provide the values displayed in report 1280. A user can select and view data for another portion of a region by using the menu next to “Geography” in the upper part of report 1280.

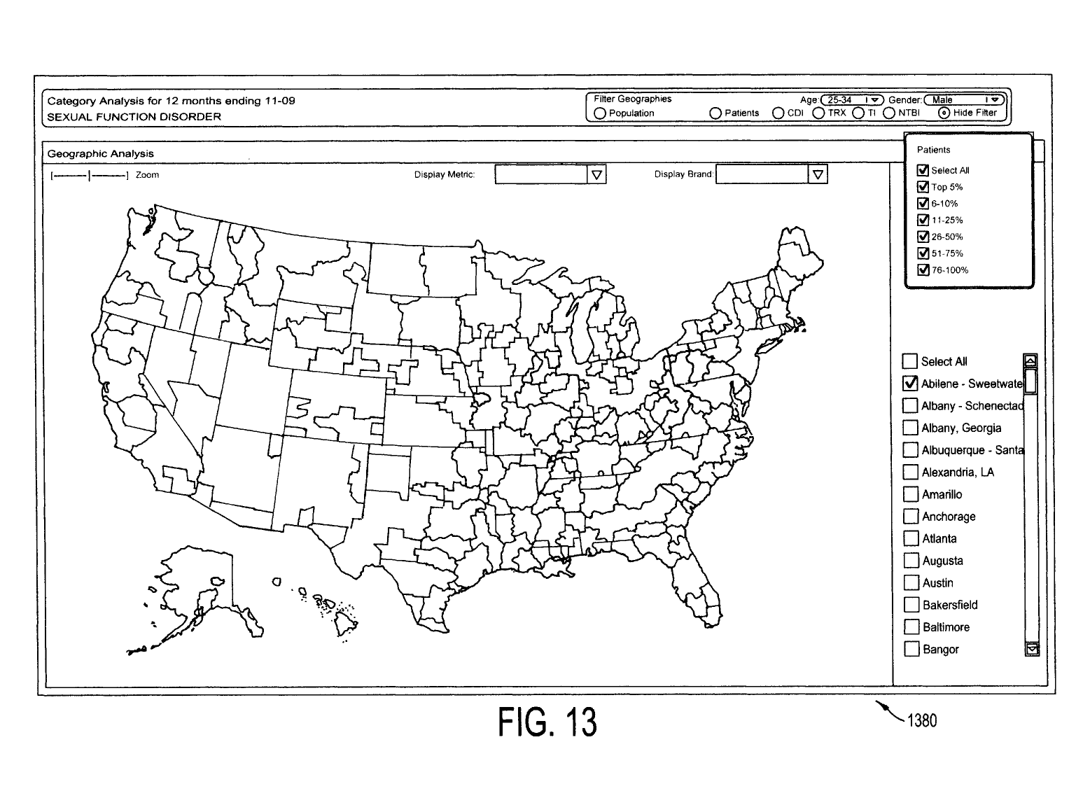

Referring to FIG. 13, a report 1380 provided by system 100 or method 200 is shown. The report 1380 provides information for an entire region during a particular period of time for a particular pharmaceutical or a particular category of pharmaceuticals. The information displayed is for the entire United States during a 12-month period ending in July 2009 and for the category of “Sexual Function Disorder,” as indicated in the upper left of the report 1380. The user can specify a particular period of time of interest at, for example, the sixth computing platform 152. Then, the sixth computing platform 152 can gather relevant information for that period of time from the reporting data 132 stored at the sixth database 112 and provide the report 1380. One or more of the determined metrics, such as CDI, TRx, TI, or NTBI, are provided in a visual format to compare quickly the metrics for one portion of a region to another portion of the region or the entire region, such as a state, a metropolitan area, a county, a city, a zip code, or a service provider area. Also, the period of time can be selected to be a day, several days, a week, several weeks, a month, several months, or some other period of time.

For example, the report 1380 can be used to measure the effectiveness of a marketing campaign. If an ad campaign promoting the use of Drug L to lower cholesterol was launched, report 1380 could provide a monthly measure of the number of prescriptions for Drug L in an area serviced by a particular cable television provider which ran the ad campaign. Another report 1380 could provide the monthly measure of the number of prescriptions for Drug L where the ads for Drug L were not run to see if the prescriptions of Drug L statistically significantly increased. If the differences in the number of prescriptions for Drug L are statistically significant, then the ad campaign for Drug L is probably effective.

The reports 380, 480, 580, 680, 780, 880, 980, 1080, 1180, 1280, and 1380 can be customized. In particular, the information in these reports can be provided rows, columns, drop down menus, pop menus, graphs, or some other way to convey information. Also, the user can make selections to retrieve a report 380, 480, 580, 680, 780, 880, 980, 1080, 1180, 1280, and 1380 for a particular region or portion of a region, a particular period of time, a particular category of pharmaceuticals, a particular pharmaceutical, and the like, at, for example, the sixth computing platform 152. The prompts for user selections can also be customized at, for example, the sixth computing platform 152. The reports 380, 480, 580, 680, 780, 880, 980, 1080, 1180, 1280, and 1380 can be filtered to display information that surpasses a certain threshold. Information from different parts of reports 380, 480, 580, 680, 780, 880, 980, 1080, 1180, 1280, and 1380 can be combined into another report. Although a few metrics, such as BDI, CDI, TI, NTBI, VI, compliance, and persistence, are discussed, in other embodiments, the system 100 and the method 200 can determine other metrics. For example, the system 100 and the method 200 can receive data regarding prescriptions and diagnoses, correlate the data about prescriptions with data about diagnoses, and provide a report detailing how many patients filled a prescription for a particular pharmaceutical and were diagnosed with each of several conditions that the pharmaceutical is indicated to treat.

While a particular embodiment has been chosen to illustrate the invention, it will be understood by those skilled in the art that various changes and modifications can be made therein without departing from the scope of the invention as defined in the appended claims.

What is claimed is:

1. A system for providing geographic prescription data, the system comprising:
an input device for receiving user selections for at least one of a portion of a region, a pharmaceutical, a category of pharmaceuticals, and a group of patients;
a presentation device for presenting a report to the user comparing information about the selected portion of the region to another portion of the region;
at least one database for storing electronic claims data; and
a computing platform in communication with the input device, the presentation device, and the at least one database, the computing platform
receives a persons of interest list,
correlates the stored electronic claims data with the persons of interest list such that all electronic claims data related to a person on the persons of interest list are correlated to the person, and
provides the report for the selected portion of the region and the selected group of patients based on the correlation of the stored electronic claims data with the persons of interest list, the report including,
prescriptions for the selected pharmaceutical,
a comparison of the prescriptions for the selected pharmaceutical to the prescriptions for the same selected pharmaceutical for the other portion of the region, and
a projected change in the prescriptions for the selected pharmaceutical based on at least one of a change in the patients prescribed the selected pharmaceutical and a change in the prescriptions per patients prescribed the selected pharmaceutical.

2. A system according to claim 1, further comprising:
another database for storing data generated from non-electronic data.

3. A system according to claim 1, further comprising:
another database for storing reporting data generated from the correlation of de-identified electronic claims data with the de-identified persons of interest list.

4. A system according to claim 1, wherein the computing platform determines a metric based on geography.

5. A system according to claim 4, wherein the metric based on geography includes portioning of a region by commercial markets.

6. A system according to claim 1, wherein the persons of interest list includes subscribers of a service provider.

7. A system according to claim 1, wherein the computing platform comprises a processor.

8. A system for providing geographic prescription data, the system comprising:
an input device for receiving user selections for at least one of a portion of a region, a pharmaceutical, a category of pharmaceuticals, and a group of patients;
a presentation device for presenting a report to the user comparing information about the selected portion of the region to another portion of the region;
at least one database for storing de-identified electronic claims data; and
a computing platform in communication with the input device, the presentation device, and the at least one database, the computing platform
receives a persons of interest list,
de-identifies the persons of interest list in the same manner as the stored de-identified electronic claims data,
correlates the de-identified electronic claims data with the de-identified persons of interest list such that all de-identified electronic claims data related to a person on the de-identified persons of interest list are correlated to the person, and
provides the report for the selected portion of the region and the selected group of patients based on the correlation of the stored de-identified electronic claims data with the de-identified persons of interest list, the report including,
prescriptions for the selected pharmaceutical,
a comparison of the prescriptions for the selected pharmaceutical to the prescriptions for the same selected pharmaceutical for the other portion of the region, and
a projected change in the prescriptions for the selected pharmaceutical based on at least one of a change in the patients prescribed the selected pharmaceutical and a change in the prescriptions per patients prescribed the selected pharmaceutical.

9. A system according to claim 8, further comprising:
another database for storing data generated from non-electronic data.

10. A system according to claim 8, further comprising:
another database for storing reporting data generated from the correlation of electronic claims data with the persons of interest list.

11. A system according to claim 8, wherein the computing platform determines a metric based on geography.

12. A system according to claim 11, wherein the metric based on geography includes portioning of a region by commercial markets.

13. A system according to claim 8, wherein the persons of interest list includes subscribers of a service provider.

14. A system according to claim 8, wherein the computing platform comprises a processor.

15. A system for providing geographic prescription data, the system comprising:
an input device for receiving user selections for at least one of a portion of a region, a pharmaceutical, a category of pharmaceuticals, and a group of patients;
a presentation device for presenting a report to the user comparing information about the selected portion of the region to another portion of the region;
at least one database for storing de-identified electronic claims data; and
a computing platform in communication with the input device, the presentation device, and the at least one database, the computing platform
receives a persons of interest list,
de-identifies the persons of interest list in the same manner as the stored de-identified electronic claims data,
correlates the de-identified electronic claims data with the de-identified persons of interest list such that all de-identified electronic claims data related to a person on the de-identified persons of interest list are correlated to the person,
determines metrics based on geography and the correlation of the stored de-identified electronic claims data with the de-identified persons of interest list and
provides the report for the selected portion of the region and the selected group of patients based on the determined metric and the correlation of the stored de-identified electronic claims data with the de-identified persons of interest list, the report including,
prescriptions for the selected pharmaceutical,
a comparison of the prescriptions for the selected pharmaceutical to the prescriptions for the same selected pharmaceutical for the other portion of the region, and
a projected change in the prescriptions for the selected pharmaceutical based on at least one of a change in the patients prescribed the selected pharmaceutical and a change in the prescriptions per patients prescribed the selected pharmaceutical.

16. A system according to claim 15, further comprising:
another database for storing data generated from non-electronic data.

17. A system according to claim 15, further comprising:
another database for storing reporting data generated from the correlation of electronic claims data with the persons of interest list.

18. A system according to claim 15, wherein the metric based on geography includes portioning of a region by commercial markets.

19. A system according to claim 15, wherein the persons of interest list includes subscribers of a service provider.
